(19) United States
(12) Patent Application Publication
(10) Pub. No.: US 2015/0203799 A1
(43) Pub. Date: Jul. 23, 2015

(54) MULTIPHASE LIQUID DETERGENT COMPOSITION

(71) Applicant: The Procter & Gamble Company, Cincinnati, OH (US)

(72) Inventors: Jean-Luc Phillippe BETTIOL, ETTERBEEK (BE); Katrien DECRAENE, GENT (BE); Marc Francois Theophile EVERS, Strombeek-Bever (BE); Karl Ghislain BRAECKMAN, GERPINNES (BE); Bjorn VAN OVERSTRAETE, MELLE (BE); Robby Renilde François KEULEERS, LIPPELO (SINT AMANDS) (BE); Joanna Margaret CLARKE, LEEFDAAL (BE); Roxane ROSMANINHO, AUDERGHEM (BE); Raffaele PINNA, BRUSSELS (BE); Christopher Stephen JONES, SAINT GILLES (BE)

(21) Appl. No.: 14/672,600

(22) Filed: Mar. 30, 2015

Related U.S. Application Data
(62) Division of application No. 13/548,300, filed on Jul. 13, 2012, now abandoned.
(60) Provisional application No. 61/512,150, filed on Jul. 27, 2011.

(51) Int. Cl. C11D 11/00; C11D 3/12; C11D 3/20; C11D 3/22

(52) U.S. Cl. CPC C11D 11/0023; C11D 3/222; C11D 3/1253; C11D 3/2086; C11D 3/2093

(57) ABSTRACT

The invention relates to a multiphase liquid detergent composition comprising at least two visually distinct liquid phases and a surfactant. At least one of the visually distinct phases has a high shear viscosity between about 100 cps and 15,000 cps at 20° C., a medium shear viscosity between about 5,000 cps and about 60,000 at 20° C., and a low shear viscosity between about 10,000 cps and 500,000 cps at 20° C. The present invention further relates to methods of cleaning dishware using such multiphase liquid detergent compositions.

### FIELD OF INVENTION

The present invention relates to multiphase liquid detergent compositions and, in one embodiment, multiphase liquid hand dishwashing compositions comprising at least two visually distinct phases, wherein at least one of the visually distinct phases has a high shear viscosity between about 100 cps and 15,000 cps at 20° C., a medium shear viscosity between about 5,000 cps and about 60,000 at 20° C., and a low shear viscosity between about 10,000 cps and 500,000 cps at 20° C.

### BACKGROUND OF THE INVENTION

Compositions which both provide multiple visually distinctive liquid phases and, for example, a cleansing function and a separate benefit function are well known in the art. Advantageously, it has been found that multiphase compositions provide, inter alia, an ability to simultaneously display multiple benefits, drive a desired consumer appeal and formulate with reactive and/or previously thought incompatible ingredients. However, heretofore, one problem associated with such compositions has been their instability. Specifically, during shipment and/or after long periods of time the different phases of the composition begin to mix and do not remain physically separate.

One attempt at providing stability to multi liquid phase compositions has been to control viscosity through the use of thickening agents. Although such compositions provide improved stability, they typically possess a high shear viscosity that in liquid detergents, such as hand dishwashing liquids, heavy duty laundry liquids or hard surface cleaning liquids, leads to undesired dissolution profiles, slow flow rates and messiness upon dosing. In addition, typically high levels of thickeners are required to enable sufficient viscosity to stabilize such multiphase liquid hand dishwashing detergents and, as such, lead to high formula costs and for most thickeners limit formulation to translucent or opaque phases. Beyond, typical thickening agents are very sensitive to other formula compounds like salt content and finished product pH and as such limit the potential applications.

Yet another solution for providing stability to a multi liquid phase composition has been to provide both a hydrophobic phase and a hydrophilic phase. Although such compositions provide multiple benefits and improved stability over the use of conventional systems, it is often difficult to achieve consistent and uniform performance because such compositions require shaking to ensure appropriate dosage of all ingredients from both phases.

Yet another attempt at providing multiple liquid phases and, in particular, a cleansing phase and a separate benefit phase while maintaining stability has been the use of dual-chamber packaging. These packages comprise separate benefit and cleansing compositions, and allow for the co-dispensing of the two in a single or dual stream. The separate cleansing and benefit compositions thus remain physically separate and stable during prolonged storage and just prior to application, but then mix during or after dispensing to provide both the cleansing and separate benefit from a physically stable system. Although such dual-chamber delivery systems provide multiple benefits and improved stability over the use of conventional systems, it is often difficult to achieve consistent and uniform performance because of the uneven dispensing ratio between the cleansing phase and the benefit phase from these dual-chamber packages. Additionally, these packaging systems add considerable cost to the finished product.

Still other solutions for providing stability to multi liquid phase compositions have been through the addition of a structurant in a lamellar phase or through the use of water-soluble structurants. Although such compositions provide improved stability over the use of conventional systems, it is often difficult to achieve consistent and uniform performance because such compositions are highly viscous and, as such, are not pleasing to liquid detergent composition consumers.

Accordingly, the need still remains for a cost-effective and easy to dose and to dissolve multiphase liquid detergent composition that provides multiple liquid phases in physical contact which each other and that remain stable for long periods of time.

### SUMMARY OF THE INVENTION

The present invention provides improvements in multi liquid phase liquid detergent compositions and provides improvements in methods of cleaning hard surfaces, such as dishware, and laundry with such multiphase liquid detergent compositions.

In one embodiment, a multiphase liquid detergent composition comprises at least two visually distinct liquid phases and a surfactant. At least one of the visually distinct phases has a high shear viscosity between about 100 cps and 15,000 cps at 20° C., a medium shear viscosity between about 5,000 cps and about 60,000 at 20° C., and a low shear viscosity between about 10,000 cps and 500,000 cps at 20° C.

In yet another embodiment of the present invention, the multi liquid phase liquid detergent composition comprising, at least one cleansing phase, at least one separate benefit phase and a structurant that are packaged in physical contact while remaining stable. It has now been found that a multiphase liquid detergent composition containing both cleansing and separate benefit phases and a structurant that are packaged in physical contact while remaining stable, can be formulated to provide improved cosmetics and skin feel during and after application while also providing excellent skin conditioning and cleansing benefits. It has been found that such a composition can be formulated with sufficiently high levels of benefit agents without compromising product lather performance and stability.

It is an object of the present invention, in yet another embodiment of the present invention, to provide a multiphase liquid detergent composition comprising at least two cleansing phases and a structurant that are separated and are packaged in physical contact while remaining stable. It has now been found that a multiphase liquid detergent composition containing at least two cleansing phases and a crystalline structurant packaged in physical contact and remaining stable over long periods of time, can be formulated to provide improved cleansing benefits. It has been found that such a composition can be formulated with reactive ingredients or with ingredients previously believed incompatible in the art without compromising product performance and stability.

The present invention further relates to methods of cleaning hard surfaces, such as dishware, and laundry with such multiphase liquid detergent compositions.

### DETAILED DESCRIPTION OF THE INVENTION

The multiphase liquid detergent compositions and methods of the present invention comprise, in one embodiment, at least two visually distinct liquid phases and a surfactant. The at least one of the visually distinct phases has a high shear viscosity between about 100 cps and 15,000 cps at 20° C., a medium shear viscosity between about 5,000 cps and about 60,000 at 20° C., and a low shear viscosity between about 10,000 cps and 500,000 cps at 20° C. In another embodiment, the multiphase liquid detergent composition and methods of the present invention comprises at least one cleaning phase and at least one separate benefit phase, a surfactant, and a crystalline structurant present in both the at least one cleaning phase and the at least one separate benefit phase. In this embodiment, the crystalline structurant is not water soluble and is present in at least one non-lamellar phase. In yet another embodiment, the multiphase liquid detergent compositions and methods of the present invention comprise at least two cleaning phases, a surfactant, and a crystalline structurant present in both the at least two cleaning phases. In this embodiment, the crystalline structurant is substantially not water soluble and is present in at least one non-lamellar phase. These and other elements of the compositions and methods of the present invention, as well as many of the optional ingredients suitable for use herein, are described in detail hereinafter.

As used herein “visually distinct liquid phases” means that the compositions comprise separate but distinguishable physical liquid spaces inside the package in which they are presented, but are in direct physical contact with one another, i.e. they are not separated by a physical barrier and they are not emulsified or mixed to significant degree. Visually distinctive means that they can be observed by a non-color blind person with the unaided naked eye at 20/20 or corrected at 20/20 with glasses or contact lenses at a distance of 30 centimeter under incandescent light, fluorescent light or sunlight. As a result, a visually distinct pattern is formed. As will be understood, a visually distinct pattern can include but is not limited to striped, marbled, rectilinear, interrupted stripes, check, mottled, veined, clustered, speckled, geometric, spotted, ribbons, helical, swirled, arrayed, variegated, textured, grooved, ridged, waved, sinusoidal, spiral, twisted, curved, cycle, streaks, striated, contoured, anisotropic, laced, weave or woven, tessellated, and combinations thereof. Each visually distinct phase might be clear, translucent or opaque, and might comprise visible suspended particles, (micro)capsules or air bubbles. Typically these particles have a particle size of 50-5000 microns in length. Visually distinctive may include, for example, areas with different colors or uncolored, shades, opacities, inclusions or particles, or different phases such as solid, liquid or gaseous (air bubbles). This would not preclude the phases from comprising two very similar compositions wherein one composition would only differ from the other through comprising a different level of pigments, dyes, particles, (micro)capsules, air bubbles and other various (optional) ingredients.

As used herein “grease” means materials comprising at least in part (i.e., at least 0.5 wt % by weight of the grease) saturated and unsaturated fats and oils, preferably oils and fats derived from animal sources such as beef and/or chicken.

As used herein “suds profile” means the amount of sudsing (high or low) and the persistence of sudsing (sustained sudsing) throughout the washing process resulting from the use of the liquid detergent composition of the present composition. As used herein “high sudsing” refers to liquid hand dishwashing detergent compositions which are both high sudsing (i.e. a level of sudsing considered acceptable to the consumer) and have sustained sudsing (i.e. a high level of sudsing maintained throughout the dishwashing operation). This is particularly important with respect to liquid dishwashing detergent compositions as the consumer uses high sudsing as an indicator of the performance of the detergent composition. Moreover, the consumer of a liquid dishwashing detergent composition also uses the sudsing profile as an indicator that the wash solution still contains active detergent ingredients. The consumer usually renews the wash solution when the sudsing subsides. Thus, a low sudsing liquid dishwashing detergent composition formulation will tend to be replaced by the consumer more frequently than is necessary because of the low sudsing level.

As used herein “dishware” means a surface such as dishes, glasses, pots, pans, baking dishes and flatware made from ceramic, china, metal, glass, plastic (polyethylene, polypropylene, polystyrene, etc.) and wood.

As used herein “liquid hand dishwashing detergent composition” refers to those compositions that are employed in manual (i.e. hand) dishwashing. Such compositions are generally high sudsing or foaming in nature.

As used herein “cleaning” means applying to a surface for the purpose of cleaning, and/or disinfecting.

As used herein, “skin benefit” means the maintenance of or increase in skin hydration and/or skin moisturization levels and/or skin conditioning, and the positive impact to the skin feel and look of hands. As used herein “moisturization” means optimization of the water level in the skin through improving the skin bather to minimize evaporation of water from the skin.

As used herein low shear viscosity is meant as the viscosity measured at a shear rate of 0.01/s. Medium shear viscosity is meant as the viscosity measured at a shear rate of 0.1/s. High shear viscosity is meant as the viscosity measured at a shear rate of 10/s.

As used herein, “not water soluble” means substantially not water soluble, i.e. poorly soluble in water is also intended.

As used herein, “perfume habituation” is the process of consumers getting used to specific perfumes upon prolonged period of times, and as such not experiencing and appreciating them anymore upon multiple uses. This is different from “perfume adaptation” where the nose gets temporary saturated by a specific perfume upon one use, but re-experiences the perfume upon the next exposure. Regularly changing perfumes over the multiple exposures helps at preventing perfume habituation.

### Product Form

The multiphase detergent compositions of the present invention can be in the form of liquid, semi-liquid, cream, lotion or gel compositions and, in some embodiments, are intended for use as liquid hand dishwashing detergent compositions for direct or indirect application onto dishware. These compositions contain, in one embodiment, at least one visually distinct phase having a high shear viscosity, as described in further detail herein, of between about 100 cps and 15,000 cps, between about 500 cps and about 10,000 cps, between about 1,000 cps and about 8,000 cps, between about 2,500 cps and about 5,000 cps and preferably about 4,000 cps. In another embodiment, the compositions contain at least one visually distinct phase having a medium shear viscosity, as described in further detail herein, of between about 5,000 cps and 60,000 cps, between about 10,000 cps and about 50,000 cps and preferably between about 20,000 cps and about 40,000 cps. In yet another embodiment, the compositions contain at least one visually distinct phase having a low shear viscosity, as described in further detail herein, of between about 10,000 cps and about 500,000 cps, between about 100,000 cps and about 400,000 cps and preferably between about 200,000 cps and about 300,000 cps. The compositions, in one embodiment, have a yield stress value of from about 0.003 Pa to about 5.0 Pa at about 20° C. as described in further detail herein. In another embodiment, the composition contains at least one cleansing phase, a benefit phase and a crystalline structurant, which are described in greater detail hereinafter. In another embodiment, these compositions contains at least two cleansing phase and a crystalline structurant, which are described in greater detail hereinafter. In yet another embodiment, these compositions contain at least one cleaning phase and at least one separate benefit phase, wherein at least one of the cleaning and benefit phases comprises a structurant and is non-lamellar, which are described in greater detail hereinafter.

### Rheology Test Method:

To characterize the desired rheology profile, low shear viscosity, medium shear viscosity, and high shear viscosity are key parameters to ensure phase stability and phase dissolution. Indeed, product dissolution is another key parameter to characterize the desired rheology and is an important product characteristic for consumers. Furthermore, when suspending particles, yield stress is yet another rheology parameter to be considered. All parameters are described in further detail herein.

### Low, Medium and High Shear Viscosity:

Viscosity can be determined by conventional methods, e.g. using an AR G2 rheometer from TA instruments using a steel spindle at 40 mm diameter and a gap size of 500 μm. The low shear viscosity at 0.01 s−1, the medium shear viscosity at 0.1 s−1 and the high shear viscosity at 10 s−1 can be obtained from a logarithmic shear rate sweep at 20° C. The procedure consists of 3 steps including a pre-conditioning, a peak hold step at 0.01 s−1 and a flow ramp up from 0.01 s−1 to 100 s−1. The pre-conditioning step consists of a pre-shear at 10 s−1 for 30 s. The peak hold step at 0.01 s−1 follows immediately, taking a sample point every 10 s. The step reaches equilibrium if the viscosity of 8 consecutive sample points is within a 2% tolerance. The flow ramp up follows immediately and consists in shearing the sample at increasing shear rates in steady state flow mode from 0.01 to 100 s−1, for 5 points per decade on a logarithmic scale, allowing measurements to stabilize for a period of from 2 s for up to 20 s with a tolerance of 2 percent. The logarithmic plot of the viscosity vs. shear rate of the last step is used to determine the low shear viscosity at 0.01 s−1, the medium shear viscosity at 0.1 s−1 and the high shear viscosity at 10 s−1.

### Yield Stress:

Without intending to be bound by theory, it is believed that although known structuring agents are disclosed to provide shear thinning capabilities, the ability of a composition to suspend particles is not in direct correlation to the shear thinning capabilities of the composition. Rather, the ability of a composition to suspend particles is measured by the yield stress. For example, two compositions having the shear thinning capabilities within a given range of shear rate can have different yield stress values. It is believed that in order to stabilize the suspended particles in the liquid matrix of the liquid detergent composition, the stress applied by one single bead or particle should not exceed the yield stress of the liquid matrix. If this condition is fulfilled the liquid detergent composition will be less susceptible to, alternatively able to prevent, sedimentation or creaming and floating or settling of the suspension particles and/or particles under static conditions.

### Yield Stress Tests:

A dynamic yield stress test is conducted. The dynamic yield stress is conducted as follows: a sample is placed in an AR G2 Stress Controlled Rheometer equipped with double concentric cylinder geometry from TA Instruments (“Rheometer”) and subjected to a range of shear from 100 s⁻¹ to 0.001 s⁻¹. Fifty measurement, spaced apart evenly in a logarithmic scale (as determined by the Rheometer) are performed at varying shear rates within the range stated, and the steady state viscosity and applied stress are measured and recorded for each imposed level of shear rate. The applied stress vs. imposed shear rate data are plotted on a chart and fitted to a modified Hershel-Bulkley model to account for the presence of a constant viscosity at high shear rate provided by the surfactant and adjunct ingredients present in the liquid matrix.

The following equation is used to model the stress of the liquid matrix:

σ=P1+P2*\dot{γ}^{P3}+P4*\dot{γ}

where: σ: Stress, dependent variable; P1: Yield stress, fit parameter; P2: Viscosity term in Hershel-Bulkley model, fit parameter; \dot{γ}: Shear rate, independent variable; P3: Exponent in the Hershel-Bulkley model, fit parameter; and P4: Asymptotic viscosity at high shear rate, fit parameter. One of ordinary skill will understand that the fitting procedure due to the Hershel-Bulkley model to the data collected from the sample will output the P1 to P4 parameters, which include the yield stress (P1). The Herschel Bulkley model is described in “Rheometry of Pastes Suspensions and Granular Material” page 163, Philippe Coussot, John Wiley & Sons, Inc., Hoboken, N.J (2005).

Without intending to be bound by theory, it is believed that yield stress is indicative of the ability of the liquid detergent composition to suspend beads. Where the yield stress of the liquid detergent composition is equal or greater than the stress applied by a single bead suspended, the bead, once suspended in the liquid matrix, should remain suspended and neither tend to float or sink. The stress applied by a suspended bead is determined based on the net force applied by the single bead, F, divided by the surface over which this force is applied, S.

$${σ}_{B} = \frac{F}{S}$$

F depends on the difference in density between the liquid matrix and the suspension particle as well as the suspension particle volume.

$$F = \frac{4}{3} \cdot π \cdot {R}^{3} \cdot ( {ρ}_{s} - {ρ}_{l} ) \cdot g$$

ρₛ and ρₗ are the densities of the suspended bead and the liquid matrix, respectively, and R is the radius of the bead, and g is gravity.

S, is calculated by:

S=K·(4·π·R²)

K has been calculated to be a constant of 3.5.

### Dissolution:

Dissolution can be measured over time using conductivity monitoring under fixed test conditions. A 5000 mL polypropylene beaker (VWR 222-1645 with diameter 185 mm and height 255 mm) is positioned underneath an overhead stirrer (IKA EUROSTAR power control-vise P7) with a 4-bladed propeller stirrer (IKA R1345, diameter 10 cm, blades inclination 45°). A steel cylindrical piece (custom made, diameter 50 mm and height 28 mm) is centered at the bottom of the beaker. The beaker is filled with 4000 mL demineralized water at 20° C., centering the middle of the blades 5 cm below the water surface. The conductivity probe (conductivity meter WTW Cond3310 with probe TetraCon 325) is placed in the water close to the beaker wall to ensure the probe opening is entirely in the water. 5 mL of the multiphase liquid detergent composition is gently placed with a syringe on the bottom of the beaker avoiding air bubbles to move to the surface. When placing at the bottom of the beaker, the product should be placed on the same spot, half way between cylindrical piece and beaker wall. The overhead stirrer is set at 75 RPM and the conductivity meter is started, immediately after the multiphase liquid detergent introduction. Conductivity values are measured at 5 second time intervals and the test ends when the conductivity reading is steady for 20 seconds. A visual check is needed to ensure there is no undissolved multiphase liquid detergent remaining in the beaker. The percent dissolved is calculated for each measured time point based on the steady endpoint conductivity value set at 100%. The dissolution time value in seconds reported is the time measured to reach 70% of the steady end conductivity value. The test is replicated twice and dissolution times recorded are averaged to obtain the final dissolution value.

### The Liquid Composition

The liquid composition of the multiphase liquid household cleaning compositions herein including hand dishwashing, heavy duty laundry and hard surface cleaning liquids, typically contain from 30% to 95%, preferably from 40% to 90%, more preferably from 50% to 85% by weight of a liquid carrier in which the other essential and optional compositions components are dissolved, dispersed or suspended. One preferred component of the liquid carrier is water. In one embodiment, the liquid composition comprises at least two visually distinct liquid phases. In yet another embodiment of the present invention, the liquid composition comprises a cleaning phase and/or benefit phases. In yet another embodiment of the present invention two or more incompatible or reactive materials are distributed over two or more visually distinctive liquid layers, aiming at maintaining chemical or physical stability of desired actives, alternatively aiming at in-situ generation of desired actives upon use of the product.

The liquid hand dishwashing compositions herein may have any suitable pH. Preferably the pH of the composition is adjusted to between 3 and 14, more preferably between 4 and 13, more preferably between 6 and 12 most preferably between 8 and 10. The pH of the composition can be adjusted using pH modifying ingredients known in the art.

These compositions contain at least one visually distinct phase and, alternatively, 2, 3, 4, 5 or more phases, having a high shear viscosity, of between about 100 cps and 15,000 cps, between about 500 cps and about 10,000 cps, between about 1,000 cps and about 8,000 cps, between about 2,500 cps and about 5,000 cps and preferably about 4,000 cps. In another embodiment, the compositions contain at least one visually distinct phase having a medium shear viscosity, of between about 5,000 cps and 60,000 cps, between about 10,000 cps and about 50,000 cps and preferably between about 20,000 cps and about 40,000 cps. In yet another embodiment, the compositions contain at least one visually distinct phase having a low shear viscosity, of between about 10,000 cps and about 500,000 cps, between about 100,000 cps and about 400,000 cps and preferably between about 200,000 cps and about 300,000 cps. Such a preferred rheology may be achieved, in some embodiments, using internal structurants with detergent ingredients as known in the art, in other embodiments, by employing an external structurant, as described in greater detail herein or, in yet other embodiments, by using combinations thereof. In one embodiment, the composition has a yield stress value of from about 0.003 Pa to about 5.0 Pa at about 20° C. and, alternatively, from about 0.01 Pa to about 3.0 Pa, from about 0.1 Pa to about 2.0 Pa and from about 0.5 Pa to about 1.0 Pa.

Furthermore, the compositions of the present invention encompass at least the use of one isotropic or non lamellar phase comprising a structurant to achieve the desired multiphase composition.

Specifically, it is generally accepted that a surfactant, which has two immiscible hydrophilic and hydrophobic parts within the same molecule, is called an amphiphilic molecule and that most amphiphilics show lyotropic liquid-crystalline phase sequences. Soap is, for example, a well known of the amphiphilic with a lyotropic liquid crystal behavior.

A lyotropic liquid crystal exhibits liquid-crystalline properties in certain concentration ranges or conditions, such as solvent concentrations or temperature. It is generally accepted that in surfactant composition, the content of water or other solvent molecules changes the self-assembled structures of the amphiphilic surfactant. For example, it is generally accepted that ethanol is an excellent solvent in an aqueous solution for inducing non-lamellar phases. There are distinct differences between these phases as well as their subcategory phase descriptions. Lipids can undergo polymorphic or mesomorphic changes leading to the formation of lamellar or non-lamellar phases.

Temperature is another contributor to phase changes. For example, when a low temperature is applied a lipid can initially be in the lamellar phase, but as the temperature increases it transitions into a non-lamellar phase. It is generally accepted to consider the most common temperature range, such as from 5 to 40° C., when discussing the most common phase of a liquid composition. In other words, a composition showing lamellar behavior at any temperature between 5 to 40° C. will be considered as being a lamellar phase.

At low amphiphile concentration or in presence of the appropriate amount of solvent the surfactant will be dispersed randomly without any ordering. It is generally accepted that in such conditions the properties of the compositions is not dependent on the direction along which they are measured and so by definition the composition is an isotropic liquid with no orientation order. Conversely, the behavior of the liquid surfactant composition at higher concentration of solvent isn't as ordered as a solid, but yet have some degree of alignment and may form a lamellar phase (neat soap phase), wherein extended sheets of amphiphiles are separated by thin layers of water.

Furthermore, it is generally accepted that lamellar phases poorly solubilizes any appreciable amounts or time compare to other phases and, for this reason, lamelar phases are typically not part of the present invention. However, in some embodiments, lamellar phases may be present.

### Internal Structurant:

Typical formulation approaches to create an internally structured liquid include creation of an aqueous surfactant mesophase or a dispersion of a mesophase in a continuous aqueous medium which has the ability to immobilize non-colloidal, water insoluble particles while the system is at rest. Suitable surfactant mesophases include dispersed lamellar, spherulitic and expanded lamellar phases. More details on these phases are described in U.S. Pat. No. 4,659,497, EP151884 and EP530708. Alternatively, an internally structured liquid can be obtained by mixing a surfactant with any non-surfactant active capable of interacting with the surfactant to form or enhance (e.g. increase the yield point of) a structured system. This non-surfactant active typically is a surfactant de-solubilizer, typically an electrolyte. More detailed description on these internally structured liquids is described in EP1979460. When translucency is preferred, the phase should preferably be of the expanded L-alpha phase, with a d-spacing of greater than 5 nm, more preferably 10<d-spacing <15 nm Other suitable structures will comprise dispersed lamellar phases, spherulitic phases, and mixtures of those, though these will typically render the solution opaque. Least preferred phases are those comprising L1 and H1 phases due to their high viscosity profile inherent to the latter, and the absence of yield stress for the former.

### External Structurant:

In one embodiment of the present invention, at least one of the visually distinct phases of the multiphase liquid detergent composition herein further comprises one or more external structurants. In one embodiment of the present invention, any one, both or more of the visually distinct phases comprise one or more external structurants. In yet another embodiment of the present invention, any one, both or more of the visually distinct phases comprise different or the same external structurants. One objective in adding such an external structurant to the compositions herein is to arrive at liquid compositions which are suitably functional and aesthetically pleasing from the standpoint of product thickness and appearance, product pourability, product optical properties, and/or particles suspension performance. In addition, by adding the structurant to both the cleaning phase and separate benefit phase enables the multiphase composition to be packaged in physical contact and remain stable for up to 2 years at 20° C.

Generally, the external structurant will be comprised at a level of from 0.001% to 3% by weight, alternatively from 0.01% to 1% by weight, more alternatively from 0.02% to 0.8% by weight of the composition. In one preferred embodiment, the external structurant will provide microfibrils an aspect ratio greater than 500, preferably greater than 750, and more preferably greater than 1000, most preferably an aspect ratio of greater than 1000. In yet another embodiment, the external structurant has is a fibril with a length and diameter. In this embodiment, the fibril length is preferably greater than 100 micron and microfibril diameter is preferably smaller than 1 micron, even more preferably about 0.1 micron. Further, in this embodiment, the aspect ratio of the fibril is defined as the ratio of length over the diameter of the microfibril and preferably has the aspect ratio as defined above.

In one embodiment the external structurant occurs as a bundle of fibrils connected through inter-fibril cross-links. In one preferred embodiment, the fibril bundles provide an aspect ratio greater than 500, preferably greater than 750, and more preferably greater than 1000, even more preferably an aspect ratio of greater than 1000. In this embodiment, the fibril bundle length is preferably greater than 100 micron and the fibril bundle diameter is preferably below 1 micron, most preferably about 0.1 micron. Further, in this embodiment, the aspect ratio of the microfibril bundle is defined as the ratio of length over the diameter of the microfibril bundle and can be measured through polarized light microscopy, as known in the art. In this embodiment, the aspect ratio is preferably as defined above.

One preferred structurant for use in the present invention is Micro Fibril Cellulose (MFC) such as described in US 2008/0108714 (CP Kelco) or US2010/0210501 (P&G). Microfibrous cellulose, bacterially derived or otherwise, can be used to provide suspension of particulates in surfactant-thickened systems as well as in formulations with high surfactant concentrations. Such MFC is usually present at concentrations from about 0.01% to about 1%, but the concentration will depend on the desired product. For example, while from 0.02 to 0.05% is preferred for suspending small mica platelets in liquid detergent composition. Preferably, MFC is used with co-agents and/or co-processing agents such as cationic polysaccharides, hydrophobically modified cationic polysaccharides, or mixtures thereof. In one preferred embodiment, the MFC is co-processed with (modified) carboxymethylcellulose (CMC) and quaternized guar gums and/or co-processing agents such as xanthan, and/or guar gum with the microfibrous cellulose. US2008/0108714 describes MFC in combination with xanthan gum, and CMC in a weight ratio of 6:3:1, respectively, and MFC, guar gum, and CMC in a ratio of 3:1:1, respectfully. These blends allow preparation of MFC as a dry product which can be “activated” with high shear or high extensional mixing into water or other water-based solutions. “Activation” occurs when the MFC blends are added to water and the co-agents/co-processing agents are hydrated. After the hydration of the co-agents/co-processing agents, high shear is generally then needed to effectively disperse the MFC to produce a three-dimensional functional network that exhibits a true yield point. One example of a commercially available MFC: Cellulon® from CPKelko.

Another type of structuring agent which is especially useful in the compositions of the present invention comprises non-polymeric (except for conventional alkoxylation), crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes.

In a preferred embodiment, the structurant is indeed a crystalline, hydroxyl-containing rheology modifier such as castor oil and its derivatives. Especially preferred are hydrogenated castor oil derivatives such as hydrogenated castor oil and hydrogenated castor wax. Commercially available, castor oil-based, crystalline, hydroxyl-containing rheology modifiers include THIXCIN® from Rheox, Inc. (now Elementis).

Alternative commercially available materials that are suitable for use as crystalline, hydroxyl-containing rheology modifiers are those of Formula III hereinbefore. An example of a rheology modifier of this type is 1,4-di-O-benzyl-D-Threitol in the R,R, and S,S forms and any mixtures, optically active or not. These preferred crystalline, hydroxyl-containing rheology modifiers, and their incorporation into aqueous shear-thinning matrices, are described in greater detail in U.S. Pat. No. 6,080,708 and in PCT Publication No. WO 02/40627.

Other types of structurants, besides the non-polymeric, crystalline, hydroxyl-containing rheology modifiers described hereinbefore, may be utilized in the liquid detergent compositions herein. Polymeric materials which will provide shear-thinning characteristics to the aqueous liquid matrix may also be employed. Fluid detergent compositions of the present invention may comprise from 0.01 to 5% by weight of a naturally derived and/or synthetic polymeric structurant. Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Polysaccharide derivatives include but are not limited to pectine, alginate, arabinogalactan (gum Arabic), carrageenan, gum karaya, gum tragacanth, gellan gum, xanthan gum and guar gum. Gellan gum is commercially marketed by CP Kelco U.S., Inc. under the KELCOGEL tradename. Examples of synthetic polymeric structurants of use in the present invention include: polycarboxylates, polyacrylates, hydrophobically modified ethoxylated urethanes, hydrophobically modified nonionic polyols and mixtures thereof. In another preferred embodiment, the polyacrylate is a copolymer of unsaturated mono- or di-carbonic acid and C1-C30 alkyl ester of the (meth)acrylic acid.

A further alternative and suitable structurant is a combination of a solvent and a polycarboxylate polymer. More specifically the solvent is preferably an alkylene glycol. More preferably the solvent is dipropyglycol. Preferably the polycarboxylate polymer is a polyacrylate, polymethacrylate, polymaleate, or mixtures thereof. In one embodiment, the polymer may or may not be sulfonated and, in one particular embodiment, the polymer comprise 2-acrylamido-2-methylpropanesulfonate, 3-allyloxy-2hydroxy-1-propanesulfonate, or combinations thereof. The solvent is preferably present at a level of from 0.5 to 15%, preferably from 2 to 9% of the composition. The polycarboxylate polymer is preferably present at a level of from 0.1 to 10%, more preferably 2 to 5% of the composition. The solvent component preferably comprises a mixture of dipropyleneglycol and 1,2-propanediol. The weight ratio of dipropyleneglycol to 1,2-propanediol is preferably 3:1 to 1:3, more preferably 1:1. The polyacrylate is preferably a copolymer of unsaturated mono- or di-carboxylic acid and 1-30C alkyl ester of the (meth) acrylic acid. In another preferred embodiment the rheology modifier is a polyacrylate of unsaturated mono- or di-carboxylic acid and 1-30C alkyl ester of the (meth) acrylic acid. Such copolymers are available from Lubrizol Corp. under the tradename Carbopol Aqua 30. A further alternative cross-linked polymer is Carbopol Aqua SF-1. In another preferred embodiment, the rheology modifier is a partially cross-linked polycarboxylate thickener available from Dow Chemical's under the ACULYN tradename.

Another suitable structurant is cross-linked polyvinylpyrrolidone available under the tradename FlexiThix from ISP

Another class of suitable structurants are those usually referred to as Hydrophobically modified Ethoxylated Urethane (HEUR). These form a class of associative thickeners that are available under the tradename Acusol 880 and Acusol 882 from Dow Chemicals.

Another class of suitable structurants are those usually referred to as Alkali Soluble Emulsions (ASE) that thicken via a non-associative swelling mechanism. These rheology modifiers are available from Dow Chemical's under the tradename Acusol 810A, 830, 835, or 842.

Another class of suitable structurants are those usually referred to as Hydrophobically modified Alkali Soluble Emulsions (HASE), that thicken via an associative swelling mechanism involving interaction with surfactants when present in the formulation. These rheology modifiers are available from Dow Chemical's under the tradename Acusol 801S, 805S, 820, or 823, or from BASF under the tradename Rheovis AT120.

Another class of suitable structurants are those consisting of clays, such as a smectite clay. The clay may be natural, but is preferably synthetic. Synthetic smectites are synthesised from a combination of metallic salts such as salts of sodium, magnesium and lithium with silicates, especially sodium silicates, at controlled ratios and temperature. This produces an amorphous precipitate that is then partially crystallised by any known method, such as high temperature treatment. The resultant product is then filtered, washed, dried and milled. In a particularly preferred embodiment, the smectite-type clay is used as a powder containing platelets that have an average platelet size of less than 100 nm. The platelet size as used herein refers to the longest linear dimension of a given platelet.

The smectite-type clay is preferably selected from the group consisting of laponites, aluminium silicate, bentonite. The preferred clay can be either naturally occurring, but are preferably synthetic. Preferred synthetic clays include the synthetic smectite-type clay sold under the trademark Laponite by Southern Clay Products, Inc. Particularly useful are gel forming grades such as Laponite RD and sol forming grades such as Laponite RDS. Natural occurring clays include some smectite and attapulgite clays. More preferred for use herein are synthetic smectite-type clays such as Laponite and other synthetic clays having an average platelet size maximum dimension of less than about 100 nm. Laponite has a layer structure, which in dispersion in water, is in the form of disc-shaped crystals of about 1 nm thick and about 25 nm diameter. Small platelet size is valuable herein for providing good stability, dissolution and desirable clear aesthetics.

Another preferred embodiment are amido-gellants. Amido-gellants provide a solution for structuring fluid detergent compositions while also being compatible with a broad range of optional detergent ingredients, such as bleaches and/or enzymes. They also provide an aesthetically pleasing pour profile without negatively impacting the composition clarity. Typical levels include from 0.01 wt % to 10 wt % of a amido-gellant as an external structuring system.

pH tuneable amido gellants, having a pKa of from 1-30, provide the fluid detergent composition with a viscosity profile that is dependent on the pH of the composition. The pH tuneable amido gellants comprise at least one pH sensitive group. When a pH tuneable amido gellant is added to a polar protic solvent such as water, it is believed that the nonionic species form the viscosity building network while the ionic species are soluble and do not form a viscosity building network. By increasing or decreasing the pH (depending on the selection of the pH-sensitive groups) the amido gellant is either protonated or deprotonated. Thus, by changing the pH of the solution, the solubility, and hence the viscosity building behaviour, of the amido gellant can be controlled. By careful selection of the pH-sensitive groups, the pKa of the amido gellant can be tailored. Hence, the choice of the pH-sensitive groups can be used to select the pH at which the amido gellant builds viscosity.

Detailed but not limiting amido-gellant and pH tuneable amido-gellant structures are described in U.S. patent application Ser. Nos. 13/045,577, 13/045,659, 13/045,749 and 13/045,768, the disclosures of which are incorporated herein by reference.

Another preferred embodiment includes Di-benzylidene Polyol Acetal Derivatives. The fluid detergent composition may comprise from 0.01% to 1% by weight of a dibenzylidene polyol acetal derivative (DBPA), preferably from 0.05% to 0.8%, more preferably from 0.1% to 0.6%, most preferably from 0.3% to 0.5%. In one embodiment, the DBPA derivative may comprise a dibenzylidene sorbitol acetal derivative (DBS).

In yet another embodiment, the composition may comprise a polyhydric alcohol having an average molecular weight of less than 600. Examples of suitable polyhydric alcohols include glycerine, ethylene glycol, diethyleneglycol, propylene glycol, polypropyleneglycol, polyethyleneglycol, di- and tri-glycerin and/or poly-glycerin and combinations thereof.

In another embodiment, fatty esters can be used to reduce the viscosity of the composition where required, such as, for example, to avoid dosing pouring issues. In particular, the fatty esters can be selected from the group of isopropyl myristate, isopropyl palmitate and isopropyl isostearate.

### Cleaning Phase

The multiphase liquid detergent compositions of the present invention, in some embodiments, comprise an aqueous cleaning phase that contains a surfactant suitable for application to dishware, skin or fabrics. Suitable surfactants for use herein include any known or otherwise effective cleansing surfactant suitable for application to the skin, and which is otherwise compatible with the other essential ingredients in the aqueous cleansing phase of the compositions. These cleansing surfactants may include anionic, nonionic, cationic, zwitterionic or amphoteric surfactants, or combinations thereof. In some embodiments, the cleansing surfactant phase in the present invention exhibits Non-Newtonian shear thinning behavior.

The aqueous cleansing phase of the liquid detergent compositions comprises surfactant at concentrations ranging from about 1 to about 50%, more preferably from about 5 to about 40%, even more preferably from about 8 to 35% by weight of the liquid detergent composition. In one embodiment of the present invention, the surfactant concentrations ranges from about 1 to about 40%, preferably from about 6 to about 32%, more preferably from about 8 to about 25% weight of the total composition of an anionic surfactant combined with about 0.01 to about 20%, preferably from about 0.2 to about 15%, more preferably from about 0.5 to about 10% by weight of the liquid detergent composition amphoteric and/or zwitterionic and/or nonionic surfactant, more preferably an amphoteric or zwitterionic and even more preferred an amine oxide surfactant or betaine surfactant, most preferred an amine oxide surfactant. Non-limiting examples of optional surfactants are discussed below. The preferred pH range of the cleansing phase is from about 3 and about 14, more preferably between 4 and about 13, even more preferably between about 6 and about 12, most preferably between about 8 and about 10.

### Anionic Surfactant

In one embodiment of the present invention, the cleaning phase of the present invention will comprise an anionic surfactant typically at a level of 1% to 40%, preferably 6% to 32%, more preferably 8% to 25% weight of the liquid detergent composition. In a preferred embodiment the composition has no more than 15%, preferably no more than 10%, more preferably no more than 5% by weight of the total composition, of a sulfonate surfactant.

Suitable anionic surfactants to be used in the compositions and methods of the present invention are sulfate, sulfonate, sulfosuccinates and/or sulfoacetate; preferably alkyl sulfate and/or alkyl ethoxy sulfates; more preferably a combination of alkyl sulfates and/or alkyl ethoxy sulfates with a combined ethoxylation degree less than 5, preferably less than 3, more preferably less than 2.

### Sulphate Surfactants

Suitable sulphate surfactants may include water-soluble salts or acids of C₁₀-C₁₄ alkyl or hydroxyalkyl, sulphate and/or ether sulfate. Suitable counterions include hydrogen, alkali metal cation or ammonium or substituted ammonium, but preferably sodium.

Where the hydrocarbyl chain is branched, it preferably comprises C₁₄ alkyl branching units. The average percentage branching of the sulphate surfactant is preferably greater than 30%, more preferably from 35% to 80% and most preferably from 40% to 60% of the total hydrocarbyl chains.

The sulphate surfactants may be selected from C₈-C₂₀ primary, branched-chain and random alkyl sulphates (AS); C₁₀-C₁₈ secondary (2,3) alkyl sulphates; C₁₀-C₁₈ alkyl alkoxy sulphates (AEₓS) wherein preferably x is from 1-30; C₁₀-C₁₈ alkyl alkoxy carboxylates preferably comprising 1-5 ethoxy units; mid-chain branched alkyl sulphates as discussed in U.S. Pat. No. 6,020,303 and U.S. Pat. No. 6,060,443; mid-chain branched alkyl alkoxy sulphates as discussed in U.S. Pat. No. 6,008,181 and U.S. Pat. No. 6,020,303.

### Alkyl Sulfosuccinates—Sulfoacetate:

Other suitable anionic surfactants are alkyl, preferably dialkyl, sulfosuccinates and/or sulfoacetate. The dialkyl sulfosuccinates may be a C₆₋₁₅ linear or branched dialkyl sulfosuccinate. The alkyl moieties may be asymmetrical (i.e., different alkyl moieties) or preferably symmetrical (i.e., the same alkyl moieties).

### Sulphonate Surfactants

The compositions of the present invention will preferably comprise no more than 15% by weight, preferably no more than 10%, even more preferably no more than 5% by weight of the liquid detergent composition, of a sulphonate surfactant. Those include water-soluble salts or acids of C₁₀-C₁₄ alkyl or hydroxyalkyl, sulphonates; C₁₁-C₁₈ alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

### Further Surfactants

The compositions can comprise further a surfactant selected from nonionic, cationic, amphoteric, zwitterionic, semi-polar nonionic surfactants, and mixtures thereof. In a further preferred embodiment, the composition of the present invention will further comprise amphoteric and/or zwitterionic surfactant, more preferably an amine oxide or betaine surfactant.

The most preferred surfactant system for the compositions of the present invention will therefore comprise: (i) 1% to 40%, preferably 6% to 32%, more preferably 8% to 25% weight of the total composition of an anionic surfactant (2) combined with 0.01% to 20% wt, preferably from 0.2% to 15% wt, more preferably from 0.5% to 10% by weight of the liquid detergent composition amphoteric and/or zwitterionic and/or nonionic surfactant, more preferably an amphoteric and even more preferred an amine oxide surfactant. It has been found that such surfactant system will provide the excellent cleaning required from a hand dishwashing liquid composition while being very soft and gentle to the hands.

The total level of surfactants is usually from 1.0% to 50% wt, preferably from 5% to 40% wt, more preferably from 8% to 35% by weight of the liquid detergent composition.

### Amphoteric and Zwitterionic Surfactants

The amphoteric and zwitterionic surfactant can be comprised at a level of from 0.01% to 20%, preferably from 0.2% to 15%, more preferably 0.5% to 10% by weight of the liquid detergent composition. Suitable amphoteric and zwitterionic surfactants are amine oxides and betaines.

Most preferred are amine oxides, especially coco dimethyl amine oxide or coco amido propyl dimethyl amine oxide. Amine oxide may have a linear or mid-branched alkyl moiety. Typical linear amine oxides include water-soluble amine oxides containing one R1 C₈₋₁₈ alkyl moiety and 2 R2 and R3 moieties selected from the group consisting of C₁₋₃ alkyl groups and C₁₋₃ hydroxyalkyl groups. Preferably amine oxide is characterized by the formula R1-N(R2)(R3)O wherein R₁ is a C₈₋₁₈ alkyl and R₂ and R₃ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides. As used herein “mid-branched” means that the amine oxide has one alkyl moiety having n₁ carbon atoms with one alkyl branch on the alkyl moiety having n₂ carbon atoms. The alkyl branch is located on the a carbon from the nitrogen on the alkyl moiety. This type of branching for the amine oxide is also known in the art as an internal amine oxide. The total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

Other suitable surfactants include betaines such alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ[CH(OH)—CH₂]_{y}—Y- (I)

wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, 0 or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃- (Ic)

R¹—CO—NH—(CH₂)₃—N⁺(CH₃)₂—CH₂CH(OH)CH₂SO₃- (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropyl betaines (Cocoamidopropylbetain).

### Nonionic Surfactants

Nonionic surfactant, when present, is comprised in a typical amount of from 0.1% to 40%, preferably 0.2% to 20%, most preferably 0.5% to 10% by weight of the liquid detergent composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol.

Also suitable are alkylpolyglycosides having the formula R²O(CₙH₂ₙO)ₜ(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose. Also suitable are alkylglycerol ethers and sorbitan esters.

Also suitable are fatty acid amide surfactants having the formula (IV):

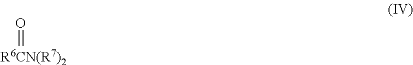

wherein R⁶ of formula (IV) is an alkyl group containing from 7 to 21, preferably from 9 to 17, carbon atoms and each R⁷ of formula (IV) is selected from the group consisting of hydrogen, C₁-C₄ alkyl, C₁-C₄ hydroxyalkyl, and —(C₂H₄O)ₓH where x of formula (IV) varies from 1 to 3. Preferred amides are C₈-C₂₀ ammonia amides, monoethanolamides, diethanolamides, and isopropanolamides.

### Cationic Surfactants

Cationic surfactants, when present in the composition, are present in an effective amount, more preferably from 0.01% to 20%, by weight of the liquid detergent composition. Suitable cationic surfactants are quaternary ammonium surfactants. Suitable quaternary ammonium surfactants are selected from the group consisting of mono C₆-C₁₆, preferably C₆-C₁₀ N-alkyl or alkenyl ammonium surfactants, wherein the remaining N positions are substituted by methyl, hydroxyehthyl or hydroxypropyl groups. Other preferred cationic surfactants include alkyl benzalkonium halides and derivatives thereof, such as those available from Lonza under the BARQUAT and BARDAC tradenames. Another preferred cationic surfactant is an C₆-C₁₈ alkyl or alkenyl ester of a quaternary ammonium alcohol, such as quaternary chlorine esters. More preferably, the cationic surfactants have the formula (V):

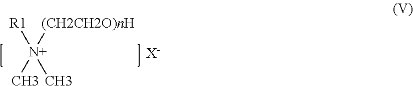

wherein R1 of formula (V) is C₈-C₁₈ hydrocarbyl and mixtures thereof, preferably, C₈₋₁₄ alkyl, more preferably, C₈, C₁₀ or C₁₂ alkyl, and X of formula (V) is an anion, preferably, chloride or bromide.

### Benefit Phase

In one embodiment, the multiphase liquid hand dishwashing compositions of the present invention may comprise at least one separate benefit phase. In one embodiment of the present invention, the benefit phase may comprise a skin benefit ingredient, a fragrance or malodor prevention benefit ingredient, a rinsing benefit ingredient, a drying benefit ingredient, a shine benefit ingredient, a soil repellency benefit ingredient, a suds boosting or stabilization ingredient, a super cleaning benefit ingredient, a food residue management benefit ingredient or mixtures thereof. In another embodiment of the present invention, the benefit phase may comprise one or a combination of the benefit ingredients mentioned above and any one, or combination thereof, of the surfactants noted above. Suitable ingredients for use in the benefit phase herein include any known or otherwise effective ingredient suitable for application to dishware or the skin, and which is otherwise compatible with the other essential ingredients in the multiphase liquid hand dishwashing detergent composition. These ingredients include but are not limited to cationic polymers, humectants, enzymes, hydrophobic emollients, skin rejuvenating actives, surface modifying polymers, carboxylic acids, chelants, cleaning polymers, soil flocculating polymers, cleaning and/or exfoliating particles, cleaning solvents, bleach and bleach activators/catalysts, antibacterial agents or combinations thereof. Furthermore functional or non-functional aesthetics and/or signaling features could be added, including suspended particles selected from the list but not limited to pearlescent agents, (deformable) beads, (interference) pigments and polymeric dyes, air or mixtures thereof.

Some of these benefit agents might also be present to a similar of lower extent within the cleaning phase.

### The Cationic Polymer

The benefit phase of the liquid hand dishwashing compositions herein may comprise at least one cationic polymer preferably having a MW below or equal to 2,100,000 and a charge density above or equal to 0.45 meq/g. The cationic polymer will typically be present a level of from 0.01 wt % to 10 wt %, preferably from 0.01 wt % to 5 wt %, more preferably from 0.05% to 1% by weight of the composition.

Suitable cationic deposition polymers for use in current invention contain cationic nitrogen containing moieties such as quaternary ammonium or cationic protonated amino moieties. The average molecular weight of the cationic deposition polymer is between about 5000 to about 10 million, preferably at least about 100000, more preferably at least about 200000, but preferably not more than about 2,100,000. The polymers also have a cationic charge density ranging from about 0.2 meq/g to about 5 meq/g, preferably at least about 0.4 meq/g, more preferably at least about 0.45 meq/g, at the pH of intended use of the dishwashing liquid formulation. As used herein the “charge density” of the cationic polymers is defined as the number of cationic sites per polymer gram atomic weight (molecular weight), and can be expressed in terms of meq/gram of cationic charge. In general, adjustments of the proportions of amine or quaternary ammonium moieties in the polymer in function of the pH of the liquid dishwashing liquid in the case of amines, will affect the charge density. Any anionic counterions can be used in association with cationic deposition polymers, so long as the polymer remains soluble in water and in the liquid hand dishwashing liquid matrix, and so long that the counterion is physically and chemically stable with the essential components of this liquid hand dishwashing liquid, or do not unduly impair product performance, stability nor aesthetics. Non-limiting examples of such counterions include halides (e.g. chlorine, fluorine, bromine, iodine), sulphate and methylsulfate.

The average molecular weight (MW) of the cationic polymer is preferably between 5,000 and 2,100,000; preferably between 15,000 and 1,000,000; more preferably between 50,000 and 600,000, even more preferably between 350,000 and 500,000. It has been found that higher MW should be avoided to avoid undesirable high rheology profiles hence limiting processability of aqueous polymer solutions, to avoid active build-up on dishware, and to avoid phase stability stress in finished product formulations.

The polymers are further characterised by a target cationic charge density above or equal to 0.45 meq/g, preferably from 0.45 to 5 meq/g, more preferably from 0.45 to 2.3 meq/g, even more preferably from 0.45 to 1.5 meq/g. It has been found indeed that such charge density is required for the formation of proper coacervates, the deposition on the skin and therefore for the required skin benefit.

Suitable cationic polymers for use in current invention contain cationic nitrogen containing moieties such as quaternary ammonium or cationic protonated amino moieties.

Specific examples of the water soluble cationized polymer include cationic polysaccharides such as cationized cellulose derivatives, cationized starch and cationized guar gum derivatives. Also included are synthetically derived copolymers such as homopolymers of diallyl quaternary ammonium salts, diallyl quaternary ammonium salt/acrylamide copolymers, quaternized polyvinylpyrrolidone derivatives, polyglycol polyamine condensates, vinylimidazolium trichloride/vinylpyrrolidone copolymers, dimethyldiallylammonium chloride copolymers, vinylpyrrolidone/quaternized dimethylaminoethyl methacrylate copolymers, polyvinylpyrrolidone/alkylamino acrylate copolymers, polyvinylpyrrolidone/alkylamino acrylate/vinylcaprolactam copolymers, vinylpyrrolidone/methacrylamidopropyl trimethylammonium chloride copolymers, alkylacrylamide/acrylate/alkylaminoalkylacrylamide/polyethylene glycol methacrylate copolymers, adipic acid/dimethylaminohydroxypropyl ethylenetriamine copolymer (“Cartaretin”—product of Sandoz/USA), and optionally quaternized/protonated condensation polymers having at least one heterocyclic end group connected to the polymer backbone through a unit derived from an alkylamide, the connection comprising an optionally substituted ethylene group (as described in WO 2007 098889, pages 2-19).

Specific commercial but non-limiting examples of the above described water soluble cationized polymers are “Merquat 550” (a copolymer of acrylamide and diallyl dimethyl ammonium salt—CTFA name: Polyquaternium-7, product of ONDEO-NALCO); “Gafquat 755N” (a copolymer of 1-vinyl-2-pyrrolidone and dimethylaminoethyl methacrylate—CTFA name: Polyquaternium-11, product ex ISP); “Polymer KG, “Polymer JR series” and “Polymer LR series” (salt of a reaction product between trimethyl ammonium substituted epoxide and hydroxyethyl cellulose—CTFA name: Polyquaternium-10, product of Amerchol); “SoftCat” polymer series (quaternized hydroxyethyl cellulose derivatives with cationic substitution of trimethyl ammonium and dimethyl dodecyl ammonium—CTFA name: Polyquaternium 67, product of Amerchol); and “Jaguar series” ex. Rhodia, “N-hance” series, and AquaCat “series” ex. Aqualon (guar hydroxypropyltrimonium chloride, and hydroxypropylguar hydroxypropyltrimonium chloride)

Preferred cationic polymers are cationic polysaccharides, including hydrophobically modified cationic polysaccharides, more preferably are cationic cellulose derivatives and/or cationic guar gums derivatives; even more preferably are cationic guar gums derivatives. Cationic cellulose derivatives are e.g. the salts of hydroxyethyl cellulose reacted with trimethyl ammonium substituted epoxide, referred to in the industry (CTFA) as Polyquatemium-10, such as UCARE JR30M, and Ucare KG30M, ex Dow Amerchol. Cationic guar gum derivatives are guar hydroxypropyltrimonium chloride, such as the Jaguar® series ex Rhodia, N-Hance® and AquaCat® polymer series available from Aqualon, specific commercial non-limiting examples of which are Jaguar® C-500, N-Hance® 3270, N-Hance® 3196, and AquaCat® CG518.

### The Humectant

The composition of the present invention comprises at least one humectant at a level of from 0.1 wt % to 50 wt %, preferably from 1 wt % to 20 wt %, more preferably from 1% to 10% by weight of the composition, even more preferably from 1% to 6% and most preferably from 2% to 5% by weight of the total composition.

Humectants that can be used according to this invention include those substances that exhibit an affinity for water and help enhance the absorption of water onto a substrate, preferably skin. Specific non-limiting examples of particularly suitable humectants include glycerol, diglycerol, polyethyleneglycol (PEG-4), propylene glycol, hexylene glycol, butylene glycol, (di)-propylene glycol, glyceryl triacetate, polyalkyleneglycols, phospholipids, collagen, elastin, ceramides, lecithin, and mixtures thereof. Others can be polyethylene glycol ether of methyl glucose, pyrrolidone caboxylic acid (PCA) and its salts, pidolic acid and salts such as sodium pidolate, polyols like sorbitol, xylitol and maltitol, or polymeric polyols like polydextrose or natural extracts like quillaia, or lactic acid or urea. Also included are alkyl polyglycosides, polybetaine polysiloxanes, and mixtures thereof. Lithium chloride is an excellent humectant but is toxic. Additional suitable humectants are polymeric humectants of the family of water soluble and/or swellable/and/or with water gelatin polysaccharides such as hyaluronic acid, chitosan and/or a fructose rich polysaccharide which is e.g. available as Fucogel®1000 (CAS-Nr 178463-23-5) by SOLABIA S.

Humectants containing oxygen atoms are preferred over those containing nitrogen or sulphur atoms. More preferred humectants are polyols or are carboxyl containing such as glycerol, diglycerol, sorbitol, Propylene glycol, Polyethylene Glycol, Butylene glycol; and/or pidolic acid and salts thereof, and most preferred are humectants selected from the group consisting of glycerol (sourced from Procter & Gamble chemicals), sorbitol, sodium lactate, and urea, or mixtures thereof.

### The Hydrophobic Emollient

The benefit phase of the present invention herein may comprise one or more hydrophobic emollients which are agents that soften or soothe the skin by slowing the evaporation of water. Hydrophobic emollients form an oily layer on the surface of the skin that slows water loss increasing skin moisture content and skin water holding capacity. Hydrophobic emollients lubricate the skin and enhance skin barrier function improving skin elasticity and appearance.

Preferably, in one embodiment of the present invention, the benefit phase comprises high levels of hydrophobic emollient, typically up to 10%, sometimes even up to 20% by weight. The hydrophobic emollient is preferably present from 0.25% to 10%, more preferably from 0.3% to 8%, most preferably from 0.5% to 6% by weight of the total composition.

Hydrophobic emollients suitable for use in the compositions herein are hydrocarbon oils and waxes; silicones; fatty acid derivatives; glyceride esters, di and tri-glycerides, acetoglyceride esters; alkyl and alkenyl esters; cholesterol and cholesterol derivatives; vegetable oils, vegetable oil derivatives, liquid nondigestible oils, or blends of liquid digestible or nondigestible oils with solid polyol polyesters; natural waxes such as lanolin and its derivatives, beeswax and its derivatives, spermaceti, candelilla, and carnauba waxes; phospholipids such as lecithin and its derivatives; sphingolipids such as ceramide; and homologs thereof and mixtures thereof.

Examples of suitable Hydrocarbon Oils and Waxes include: petrolatum, mineral oil, micro-crystalline waxes, polyalkenes (e.g. hydrogenated and nonhydrogenated polybutene and polydecene), paratrins, cerasin, ozokerite, polyethylene and perhydrosqualene. Preferred hydrocarbon oils are petrolatum and/or blends of petrolatum and mineral oil.

Examples of suitable Silicone Oils include: dimethicone copolyol, dimethylpolysiloxane, diethylpolysiloxane, high molecular weight dimethicone, mixed C₁₋₃₀alkyl polysiloxane, phenyl dimethicone, dimethiconol, and mixtures thereof. More preferred are non-volatile silicones selected from dimethicone, dimethiconol, mixed C₁₋₃₀alkyl polysiloxane, and mixtures thereof.

Examples of suitable glyceride esters include: castor oil, soy bean oil, derivatized soybean oils such as maleated soy bean oil, safflower oil, cotton seed oil, corn oil, walnut oil, peanut oil, olive oil, cod liver oil, almond oil, avocado oil, vegetable oils and vegetable oil derivatives; coconut oil and derivatized coconut oil, cottonseed oil and derivatized cottonseed oil, jojoba oil, cocoa butter, and the like. Preferred glyceride is castor oil.

In yet another embodiment of the present invention, acetoglyceride esters may also be used in the benefit phase, an example being acetylated monoglycerides.

Preferred hydrophobic emollients are petrolatum, mineral oil and/or blends of petrolatum and mineral oil; tri-glycerides such as the ones derived from vegetable oils; oily sugar derivatives; beeswax; lanolin and its derivatives including but not restricted to lanolin oil, lanolin wax, lanolin alcohols, lanolin fatty acids, isopropyl lanolate, cetylated lanolin, acetylated lanolin alcohols, lanolin alcohol linoleate, lanolin alcohol riconoleate; ethoxylated lanolin.

More preferred hydrophobic emollients are petrolatum; blends of petrolatum and mineral oil wherein the ratio petrolatum:mineral oil ranks from 90:10 to 50:50, and preferably is 70:30; vegetable oils and vegetable waxes such as castor oil, and carnauba wax; blends of petrolatum and vegetable oils such as castor oil; oily sugar derivatives such as the ones taught in WO 98/16538 which are cyclic polyol derivatives or reduced saccharide derivatives resulting from 35% to 100% of the hydroxyl group of the cyclic polyol or reduced saccharide being esterified and/or etherified and in which at least two or more ester or ether groups are independently attached to a C8 to C22 alkyl or alkenyl chain, that may be linear or branched. In the context of the present invention, the term cyclic polyol encompasses all forms of saccharides. Especially preferred are monosaccharides and disaccharides. Examples of monosaccharides include xylose, arabinose, galactose, fructose, and glucose. Example of reduced saccharide is sorbitan. Examples of disaccharides are sucrose, lactose, maltose and cellobiose. Sucrose is especially preferred. Particularly preferred are sucrose esters with 4 or more ester groups. These are commercially available under the trade name Sefose® from Procter & Gamble Chemicals, Cincinnati Ohio.

Even more preferred hydrophobic emollients are petrolatum, mineral oil, Castor oil, natural waxes such as beeswax, carnauba, spermaceti, lanolin and lanolin derivatives such as liquid lanolin or lanolin oil sold by Croda International under the trade name of Fluilan, and lanolin derivatives such as ethoxylated lanolin sold by Croda International under the trade name of Solan E (PEG-75 lanolin). Most preferred hydrophobic emollients are petrolatum, mineral oil, Castor oil, and mixtures thereof.

### Enzymes

The composition of the present invention may comprise an enzyme, preferably a protease. It has been found that such a composition comprising a protease will provide additional hand mildness benefit. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, mannanases, pentosanases, malanases, β-glucanases, arabinosidases, hyaluronidase, chondroitinase, laccase, and known amylases, or combinations thereof. A preferred enzyme combination comprises a cocktail of conventional detersive enzymes like protease, lipase, cutinase and/or cellulase in conjunction with amylase. Detersive enzymes are described in greater detail in U.S. Pat. No. 6,579,839.

Suitable proteases include those of animal, vegetable or microbial origin. Microbial origin is preferred. Chemically or genetically modified mutants are included. The protease may be a serine protease, preferably an alkaline microbial protease or a trypsin-like protease. Examples of neutral or alkaline proteases include:
(a) subtilisins (EC 3.4.21.62), especially those derived from Bacillus, such as Bacillus lentus, B. alkalophilus, B. subtilis, B. amyloliquefaciens, Bacillus licheniformis, Bacillus pumilus and Bacillus gibsonii, and Cellumonas described in U.S. Pat. No. 6,312,936 B 1, U.S. Pat. No. 5,679,630, U.S. Pat. No. 4,760,025, U.S. Pat. No. 5,030,378, WO 05/052146, DEA6022216A1 and DEA 6022224A1.
(b) trypsin-like proteases are trypsin (e.g., of porcine or bovine origin) and the Fusarium protease described in WO 89/06270.
(c) metalloproteases, especially those derived from Bacillus amyloliquefaciens described in WO 07/044993A2.

Preferred proteases for use herein include polypeptides demonstrating at least 90%, preferably at least 95%, more preferably at least 98%, even more preferably at least 99% and especially 100% identity with the wild-type enzyme from Bacillus lentus or the wild-type enzyme from Bacillus Amyloliquefaciens, comprising mutations in one or more of the following positions, using the BPN′ numbering system and amino acid abbreviations as illustrated in WO00/37627, which is incorporated herein by reference: 3, 4, 68, 76, 87, 99, 101, 103, 104, 118, 128, 129, 130, 159, 160, 167, 170, 194, 199, 205, 217, 222, 232, 236, 245, 248, 252, 256 & 259.

More preferred proteases are those derived from the BPN′ and Carlsberg families, especially the subtilisin BPN′ protease derived from Bacillus amyloliquefaciens. In one embodiment the protease is that derived from Bacillus amyloliquefaciens, comprising the Y217L mutation whose sequence is shown below in standard 1-letter amino acid nomenclature, as described in EP342177B1 (sequence given on p. 4-5).

Preferred commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, and those sold under the tradename Opticlean® and Optimase® by Solvay Enzymes. In one aspect, the preferred protease is a subtilisin BPN′ protease derived from Bacillus amyloliquefaciens, preferably comprising the Y217L mutation, sold under the tradename Purafect Prime®, supplied by Genencor International.

Enzymes may be incorporated into the compositions in accordance with the invention at a level of from 0.00001% to 1% of enzyme protein by weight of the total composition, preferably at a level of from 0.0001% to 0.5% of enzyme protein by weight of the total composition, more preferably at a level of from 0.0001% to 0.1% of enzyme protein by weight of the total composition.

The aforementioned enzymes can be provided in the form of a stabilized liquid or as a protected liquid or encapsulated enzyme. Liquid enzyme preparations may, for instance, be stabilized by adding a polyol such as propylene glycol, a sugar or sugar alcohol, lactic acid or boric acid or a protease stabilizer such as 4-formyl phenyl boronic acid according to established methods. Protected liquid enzymes or encapsulated enzymes may be prepared according to the methods disclosed in U.S. Pat. No. 4,906,396, U.S. Pat. No. 6,221,829 B1, U.S. Pat. No. 6,359,031 B1 and U.S. Pat. No. 6,242,405 B1.

### Skin Rejuvenating Actives:

Skin rejuvenating actives can be selected from the list of but are not limited to plant extracts with anti-oxidant action, vitamins, and mixtures thereof. Skin rejuvenating actives are typically formulated between 0.001% and 8%, preferably between 0.005% and 5%, even more preferred between 0.01% and 3%. Vitamins typically are selected from the group of Vitamin A (Retinol), Vitamin B2 (Riboflavin), Vitamin B5 (Panthenol), Vitamin B 12 (Cobalamine) Vitamin C (Ascorbic acid), Vitamin E (Tocopherol), Vitamin H (Biotin), folic acid and mixtures thereof. Vitamins A, C and E are acting as antioxidants and can as such slow down the ageing process, while Vitamin B acts as an anti-inflammatory and as such has a relaxing activity.

### Surface Modifying Polymers:

The composition of the present invention may comprise a surface modifying polymer. It has been found that the presence of specific water-soluble or water-dispersible copolymer in a liquid cleaning composition provides improved filming and/or streaking performance as well as improved shine performance as compared to the use of a composition that is free of specific water-soluble or water-dispersible copolymer therein. Furthermore, it has been found that the presence of specific water-soluble or water-dispersible copolymer in a liquid cleaning composition provides improved soil repellency properties to the surface after an initial cleaning operation with the composition using a process according to the present invention. Moreover, it has been found that the presence of specific water-soluble or water-dispersible copolymer in a liquid cleaning composition provides improved next time cleaning benefit properties to the surface after an initial cleaning operation with the compositions using a process according to the present invention.

Suitable but none limiting examples of such water-soluble or water-dispersible copolymers include cationic, anionic, zwitterionic or nonionic co-polymers comprising monomers selected from the groups of a) monomers comprising one or more quaternary functionality, b) hydrophilic monomers carrying a functional acidic group, c) monomer compound with ethylenic unsaturation with a neutral charge preferably a hydrophilic monomer compound with ethylenic unsaturation with a neutral charge carrying one or more hydrophilic groups, and/or d) monomers comprising a betaine or sulphobetaine group.

The monomers (a) include a compound with mono or multi-cationic functionality, ethylenic unsaturation, and derivatives thereof, the cationic unit preferably comprising a quaternary ammonium function. A well known example of this monomer type is being known as diallyl dimethyl ammonium chloride (DADMAC).

The monomers (b) are advantageously C₃-C₈ carboxylic, sulphonic, sulfuric, phosphonic or phosphoric acids with monoethylenic unsaturation, their anhydrides and their salts which are soluble in water and mixture thereof. Preferred monomers (b) are acrylic acid, methacrylic acid, α-ethacrylic acid, β,β-dimethylacrylic acid, methylenemalonic acid, vinylacetic acid, allylacetic acid, ethylidineacetic acid, propylidineacetic acid, crotonic acid, maleic acid, fumaric acid, itaconic acid, citraconic acid, mesaconic acid, N-(methacroyl)alanine, N-(acryloyl)hydroxyglycine, sulfopropyl acrylate, sulfoethyl acrylate, sulfoethyl methacrylate, styrenesulfonic acid, vinylsulfonic acid, vinylphosphonic acid, phosphoethyl acrylate, phophonoethyl acrylate, phosphopropyl acrylate, phophonopropyl acrylate, phosphoethyl methacrylate, phophonoethyl methacrylate, phosphopropyl methacrylate, phophonopropyl methacrylate and the alkali metal and ammonium salts thereof and mixtures thereof.

Optional monomers (c) can include acrylamide, vinyl alcohol, C₁-C₄ alkyl esters of acrylic acid and of methacrylic acid, C₁-C₄ hydroxyalkyl esters of acrylic acid and of methacrylic acid, in particular ethylene glycol and propylene glycol acrylate and methacrylate, polyalkoxylated esters of acrylic acid and of methacrylic acid, in particular the polyethylene glycol and polypropylene glycol esters, esters of acrylic acid or of methacrylic acid and of polyethylene glycol or polypropylene glycol C₁-C₂₅ monoalkyl ethers, vinyl acetate, vinylpyrrolidone or methyl vinyl ether and mixtures thereof.

Monomers (d) can include units comprising an anionic and a cationic group, with in the case of sulphobetaines at least one of the groups comprising a sulphur atom. The anionic group may be a carbonate group, a sulphuric group such as a sulphonate group, a phosphorous group such as a phosphate, a phosphonate, phosphinate group, or an ethanolate group. It is alternatively a sulphuric group. The cationic group may be an onium or inium group from the nitrogen, phosphate or sulphur family, for example an ammonium, pyridinium, imidazolinum, phosphonium, or sulphonium group. It is alternatively an ammonium group. Alternatively the betaine group it is a sulphobetaine group comprising a sulphonate group and a quaternary ammonium group.

A broad range of surface modifying technologies are available from Rhodia under the MIRAPOL tradename.

Typical levels of surface modifying polymers are 0.001% up to 10%, more preferably 0.01% to 5%, even more preferably 0.1 to 2%.

### Carboxylic Acid

In yet another embodiment of the present invention, the cleaning phase and/or separate benefit phase of the multiphase liquid hand dishwashing composition herein may optionally further comprise a linear or cyclic carboxylic acid or salt thereof to improve the rinse feel of the composition. The presence of anionic surfactants, especially when present in higher amounts in the region of 15-35% by weight of the total composition, results in the composition imparting a slippery feel to the hands of the user and the dishware.

Carboxylic acids useful herein include C₁₋₆ linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid and salts thereof, citric acid and salts thereof, and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof, when present, is preferably present at the level of from 0.1% to 5%, more preferably from 0.2% to 1% and most preferably from 0.25% to 0.5% by weight of the total composition.

### Polycarboxylate

The present composition may comprise a polycarboxylate polymer, a co-polymer comprising one or more carboxylic acid monomers. A water soluble carboxylic acid polymer can be prepared by polyimerizing a carboxylic acid monomer or copolymerizing two monomers, such as an unsaturated hydrophilic monomer and a hydrophilic oxyalkylated monomer. Examples of unsaturated hydrophilic monomers include acrylic acid, maleic acid, maleic anhydride, methacrylic acid, methacrylate esters and substituted methacrylate esters, vinyl acetate, vinyl alcohol, methylvinyl ether, crotonic acid, itaconic acid, vinyl acetic acid, and vinylsulphonate. The hydrophilic monomer may further be copolymerized with oxyalkylated monomers such as ethylene or propylene oxide. Preparation of oxyalkylated monomers is disclosed in U.S. Pat. No. 5,162,475 and U.S. Pat. No. 4,622,378. The hydrophilic oxyalkyated monomer preferably has a solubility of about 500 grams/liter, more preferably about 700 grams/liter in water. The unsaturated hydrophilic monomer may further be grafted with hydrophobic materials such as poly(alkene glycol) blocks. See, for example, materials discussed in U.S. Pat. No. 5,536,440, U.S. Pat. No. 5,147,576, U.S. Pat. No. 5,073,285, U.S. Pat. No. 5,534,183 U.S. Pat. No. 5,574,004, and WO 03/054044.

The polycarboxylate, when present, is preferably present at the level of from 0.1% to 5%, more preferably from 0.2% to 1% and most preferably from 0.25% to 0.5% by weight of the total composition.

### The Chelant

In yet another embodiment of the present invention, the cleaning phase and/or separate benefit phase of the multiphase liquid hand dishwashing composition herein may optionally further comprise a chelant at a level of from 0.1% to 20%, preferably from 0.2% to 5%, more preferably from 0.2% to 3% by weight of total composition.

As commonly understood in the detergent field, chelation herein means the binding or complexation of a bi- or multidentate ligand. These ligands, which are often organic compounds, are called chelants, chelators, chelating agents, and/or sequestering agent. Chelating agents form multiple bonds with a single metal ion. Chelants, are chemicals that form soluble, complex molecules with certain metal ions, inactivating the ions so that they cannot normally react with other elements or ions to produce precipitates or scale. The ligand forms a chelate complex with the substrate. The term is reserved for complexes in which the metal ion is bound to two or more atoms of the chelant. The chelants for use in the present invention are those having crystal growth inhibition properties, i.e. those that interact with the small calcium and magnesium carbonate particles preventing them from aggregating into hard scale deposit. The particles repel each other and remain suspended in the water or form loose aggregates which may settle. These loose aggregates are easily rinsed away and do not form a deposit.

Suitable chelating agents can be selected from the group consisting of amino carboxylates, amino phosphonates, polufanctionally-substituted aromatic chelating agents and mixtures thereof.

Preferred chelants for use herein are the amino acids based chelants and preferably glutamic-N,N-diacetic acid and derivatives and/or Phosphonate based chelants and preferably Diethylenetriamine penta methylphosphonic acid.

Amino carboxylates include ethylenediaminetetra-acetates, N-hydroxyethylethylenediaminetriacetates, nitrilo-triacetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein. As well as MGDA (methyl-glycine-diacetic acid), and salts and derivatives thereof and GLDA (glutamic-N,N-diacetic acid) and salts and derivatives thereof. GLDA (salts and derivatives thereof) is especially preferred according to the invention, with the tetrasodium salt thereof being especially preferred.

Other suitable chelants include amino acid based compound or a succinate based compound. The term “succinate based compound” and “succinic acid based compound” are used interchangeably herein. Other suitable chelants are described in U.S. Pat. No. 6,426,229. Particular suitable chelants include; for example, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), -alanine-N,N-diacetic acid (-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof. Also suitable is ethylenediamine disuccinate (“EDDS”), especially the [S,S] isomer as described in U.S. Pat. No. 4,704,233. Furthermore, Hydroxyethyleneiminodiacetic acid, Hydroxyiminodisuccinic acid, Hydroxyethylene diaminetriacetic acid are also suitable.

Other chelants include homopolymers and copolymers of polycarboxylic acids and their partially or completely neutralized salts, monomeric polycarboxylic acids and hydroxycarboxylic acids and their salts. Preferred salts of the abovementioned compounds are the ammonium and/or alkali metal salts, i.e. the lithium, sodium, and potassium salts, and particularly preferred salts are the sodium salts.

Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethyl enedioxy) diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Another suitable polycarboxylic acid is the homopolymer of acrylic acid. Preferred are the polycarboxylates end capped with sulfonates.

Amino phosphonates are also suitable for use as chelating agents and include ethylenediaminetetrakis (methylenephosphonates) as DEQUEST. Preferred, these amino phosphonates that do not contain alkyl or alkenyl groups with more than about 6 carbon atoms.

Polyfunctionally-substituted aromatic chelating agents are also useful in the compositions herein such as described in U.S. Pat. No. 3,812,044. Preferred compounds of this type in acid form are dihydroxydisulfobenzenes such as 1,2-dihydroxy-3,5-disulfobenzene.

Further suitable polycarboxylates chelants for use herein include citric acid, lactic acid, acetic acid, succinic acid, formic acid; all preferably in the form of a water-soluble salt. Other suitable polycarboxylates are oxodisuccinates, carboxymethyloxysuccinate and mixtures of tartrate monosuccinic and tartrate disuccinic acid such as described in U.S. Pat. No. 4,663,071.

### Cleaning Polymer

In yet another embodiment of the present invention, the cleaning phase and/or separate benefit phase of the multiphase liquid hand dishwashing composition herein may optionally further comprise one or more cleaning polymer. Any suitable cleaning polymer may be of use. Useful amphiphilic alkoxylated cleaning polymers are described in US 2009/0124528A1. The composition may comprise from 0.01 wt % to 10 wt %, preferably from 0.01 wt % to 2 wt %, more preferably from 0.1 wt % to 1.5 wt %, even more preferable from 0.2% to 1.5% by weight of the total composition of a cleaning polymer.

Especially preferred are alkoxylated polyethyleneimine polymers. The alkoxylated polyethyleneimine polymer of the present composition has a polyethyleneimine backbone having from 400 to 10000 weight average molecular weight, preferably from 400 to 7000 weight average molecular weight, alternatively from 3000 to 7000 weight average molecular weight. The alkoxylation of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom on a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety or benzyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof. These alkoxylated polyethylenimine polymers are described in greater detail in WO2007135645.

The composition may further comprise the amphiphilic graft polymers based on water soluble polyalkylene oxides (A) as a graft base and sides chains formed by polymerization of a vinyl ester component (B), said polymers having an average of <1 graft site per 50 alkylene oxide units and mean molar mass Mw of from 3,000 to 100,000 described in BASF patent application WO2007/138053 on pages 2 line 14 to page 10, line 34 and exemplified on pages 15-18.

### Soil Flocculating Polymers:

The term flocculation, as used herein, is synonymous with the term coagulation and refers to the enhanced settling of suspended solid particles from aqueous systems. Soil flocculation is typically achieved through formulating flocculating polymers, possibly combined with supplementary flocculating agents such as aluminium salts such as aluminium sulfate, aluminium chloride hydroxide, sodium aluminate and aluminium silicate. Soil flocculating polymers typically are formulated between 0.01% and 10%, more preferably between 0.05% and 5%, even more preferably between 0.01% and 1%. These polymers are typically selected from the group consisting of polyacrylamide and copolymers, copolymers of polyacrylamide and acrylic acid, acrylic acid and copolymers, methacrylic acid and copolymers, polyethyleneimines, polyethylene oxide and copolymers and derivatives of a natural polymer. A non-limiting list of possible flocculating agents is described in US2004008929 (The Clorox Company).

### Cleaning and Exfoliating Particles:

In one embodiment of the present invention, the composition may comprise cleaning and/or exfoliating particles. In one preferred embodiment, the inventive products may comprise abrasive particles selected from the group consisting of polymers, natural materials, hard waxes, ceramic particles, inorganic substances and mixtures thereof.

If present, these particles are formulated at relatively low levels, such as preferably from 0.1% to 20%, preferably from 0.1% to 10%, more preferably from 0.5% to 5%, even more preferably from 0.5% to 3%, most preferably from 0.5% to 2%, by weight of the total composition of said abrasive cleaning and exfoliating particles.

In this context, the exfoliating polymer is preferably selected from the group consisting of polyethylene, polypropylene, polystyrene, polyethylene terephtalate, polyester, polycarbonate, polyvinyl chloride, polyvinylacetate, polymethylmethacrylate, polyurethane and copolymers and mixtures thereof.

Preferably, abrasive cleaning and exfoliating particles can be produced from the polyurethane foam, which is formed in the reaction between diisocyanate monomers and polyols, wherein the diisocyanate monomer can be aliphatic and/or aromatic, in the presence of catalyst, materials for controlling the cell structure and surfactants. Polyurethane foam can be made in a variety of densities and hardness's by varying the type of diisocyanate monomer(s) and polyols and by adding other substances to modify their characteristics. Other additives can be used to improve the stability of the polyurethane foam and other properties of the polyurethane foam.

Preferably, the composition herein comprise abrasive cleaning and exfoliating particles that are selected or synthesized to feature effective shapes, e.g.: defined by roughness and adequate hardness, particularly said particles are formed by shearing and/or graining polyurethane foam.

Alternatively, the compositions described herein may comprise natural abrasive cleaning particles formed by shearing and/or grinding nut shell, or other plant parts such as, but not limited to stems, roots, leaves, seeds, roots and mixtures thereof. Wood can also be used to produce the abrasive cleaning and exfoliating particles of the present composition.

Preferably, nut shell is selected from the group consisting of but not limited to walnut shell, almond shell, hazelnut shell, macadamia nut shell, pine nut shell, coconuts and further nuts and mixtures thereof. Preferably, the nut shell is a walnut shell.

When other plant parts are used to produce the cleaning and exfoliating particles of the present composition, they are preferably derived from rice, corn cob, palm biomass, kenaf, loofa, apple seeds, apricot stone, peach stones, prune stones, grape seeds, olive stone, cherry stone, Tagua palm (Phyleteas genus) seed, Doum palm (Hyphaene genus) seed, Sago palm (Metroxylon genus) seed and mixtures thereof. Preferred are particles derived from olive stone, cherry stone, and tagua palm seed endosperm known as vegetable ivory.

The natural abrasive particles used herein may be coated, coloured, and/or bleached in any suitable manner available in the art to achieve particles with an appearance that can provide a more appealing product aesthetics.

Alternatively, usable inorganic compounds include for example alkali metal carbonates, alkali metal bicarbonates and alkali metal sulfates, alkali metal borates, alkali metal phosphates, silicon dioxide, crystalline or amorphous alkali metal silicates and sheet silicates, finely crystalline sodium aluminium silicates, aluminium oxides and calcium carbonate.

### Cleaning Solvents:

The liquid compositions of the present invention may comprise a grease cleaning solvent, or mixtures thereof as a highly preferred optional ingredient. Suitable solvent is selected from the group consisting of: ethers and diethers having from 4 to 14 carbon atoms, preferably from 6 to 12 carbon atoms, and more preferably from 8 to 10 carbon atoms; glycols or alkoxylated glycols; alkoxylated aromatic alcohols; aromatic alcohols; alkoxylated aliphatic alcohols; aliphatic alcohols; C8-C14 alkyl and cycloalkyl hydrocarbons and halohydrocarbons; C6-C16 glycol ethers; alkanolamines; terpenes and mixtures thereof.

Suitable glycols to be used herein are according to the formula HO—CR1R2-OH wherein R1 and R2 are independently H or a C2-C10 saturated or unsaturated aliphatic hydrocarbon chain and/or cyclic. Suitable glycols to be used herein are dodecaneglycol and/or propanediol.

Suitable alkoxylated glycols to be used herein are according to the formula R-(A)n-R1-OH wherein R is H, OH, a linear or branched, saturated or unsaturated alkyl of from 1 to 20 carbon atoms, preferably from 2 to 15 and more preferably from 2 to 10, wherein R1 is H or a linear saturated or unsaturated alkyl of from 1 to 20 carbon atoms, preferably from 2 to 15 and more preferably from 2 to 10, and A is an alkoxy group preferably ethoxy, methoxy, and/or propoxy and n is from 1 to 5, preferably 1 to 2. Suitable alkoxylated glycols to be used herein are methoxy octadecanol and/or ethoxyethoxyethanol.

Suitable alkoxylated aromatic alcohols to be used herein are according to the formula R-(A)n-OH wherein R is an alkyl substituted or non-alkyl substituted aryl group of from 1 to 20 carbon atoms, preferably from 2 to 15 and more preferably from 2 to 10, wherein A is an alkoxy group preferably butoxy, propoxy and/or ethoxy, and n is an integer of from 1 to 5, preferably 1 to 2. Suitable alkoxylated aromatic alcohols are benzoxyethanol and/or benzoxypropanol. Suitable aromatic alcohols to be used herein are according to the formula R—OH wherein R is an alkyl substituted or non-alkyl substituted aryl group of from 1 to 20 carbon atoms, preferably from 1 to 15 and more preferably from 1 to 10. For example a suitable aromatic alcohol to be used herein is benzyl alcohol.

Suitable alkoxylated aliphatic alcohols to be used herein are according to the formula R-(A)n-OH wherein R is a linear or branched, saturated or unsaturated alkyl group of from 1 to 20 carbon atoms, preferably from 2 to 15 and more preferably from 3 to 12, wherein A is an alkoxy group preferably butoxy, propoxy and/or ethoxy, and n is an integer of from 1 to 5, preferably 1 to 2. Suitable alkoxylated aliphatic linear or branched alcohols are butoxy propoxy propanol (n-BPP), butoxyethanol, butoxypropanol (n-BP), ethoxyethanol, 1-methylpropoxyethanol, 2-methylbutoxyethanol, Hexyl glycol ether (Hexyl Cellosolve) and Hexyl diglycolether (HexylCarbitiol) or mixtures thereof. Butoxy propoxy propanol is commercially available under the trade name n-BPP® from Dow chemical. Butoxypropanol is commercially available from Dow chemical.

Suitable aliphatic alcohols to be used herein are according to the formula R—OH wherein R is a linear or branched, saturated or unsaturated alkyl group of from 1 to 20 carbon atoms, preferably from 2 to 15 and more preferably from 5 to 12. With the proviso that said aliphatic branched alcohols is not a 2-alkyl alkanol as described herein above. Suitable aliphatic alcohols are methanol, ethanol, propanol, isopropanol or mixtures thereof.

Suitable alkanolamines to be used herein include but are not limited to monoethanolamine, diethanolamine and triethanolamine.

Suitable terpenes to be used herein monocyclic terpenes, dicyclic terpenes and/or acyclic terpenes. Suitable terpenes are: D-limonene; pinene; pine oil; terpinene; terpene derivatives as menthol, terpineol, geraniol, thymol; and the citronella or citronellol types of ingredients.

Other suitable solvents include butyl diglycol ether (BDGE), hexandiols, butyltriglycol ether, teramilic alcohol and the like. BDGE is commercially available from Union Carbide or from BASF under the trade name Butyl CARBITOL®. Alternatively also diamines can be used. Specific examples of diamines are described further in the document in the other optional ingredients section.

Preferably said solvent is selected from the group consisting of butoxy propoxy propanol, butyl diglycol ether, benzyl alcohol, butoxypropanol, ethanol, methanol, isopropanol, hexandiols and mixtures thereof. More preferably said solvent is selected from the group consisting of butoxy propoxy propanol, butyl diglycol ether, benzyl alcohol, butoxypropanol, ethanol, methanol, isopropanol and mixtures thereof. Even more preferably said solvent is selected from the group consisting of butyl diglycol ether, butoxypropanol, ethanol and mixtures thereof.

Typically, the liquid composition herein may comprise up to 30%, preferably from 1% to 25%, more preferably from 1% to 20% and most preferably from 2% to 10% by weight of the total composition of said solvent or mixture thereof.

### Bleach and Bleach Activators/Catalysts:

One embodiment is a composition, wherein one of the phase may contain from 0.1% to 12% by weight of a bleach or bleach system, preferably a peroxide bleach, and further comprises a neat pH of from 2 to 9, possibly in combinations with chelant, radical scavenger and specific surfactant system such as dodecyl dimethylamine oxide and derivatives. More details are described in EPO application serial number 10177812.4. The peroxygen bleach component in the composition can be formulated with an activator (peracid precursor), present at levels of from 0.01 to 15%, preferably from 0.5 to 10%, more preferably from 1% to 8% by weight of the composition.

Another embodiment of the present invention is that one of the phases may contain a bleach activator when the other ones contain bleach. Preferred activators are selected from the group consisting of: tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C10-OB5), benzoylvalerolactam (BZVL), octanoyloxybenzenesulphonate (C8-OBS), perhydrolyzable esters and mixtures thereof, alternatively benzoylcaprolactam and benzoylvalerolactam, 4-[N-(nonaoyl) amino hexanoyloxy]-benzene sulfonate sodium salt (NACA-OBS) (See U.S. Pat. No. 5,523,434), dodecanoyloxy-benzenesulphonate (LOBS or C12-OBS), 10-undecenoyloxybenzenesulfonate (UDOBS or C11-OBS with unsaturation in the 10 position), and decanoyloxybenzoic acid (DOBA) and mixtures thereof. Non-limiting examples of suitable bleach activators, including quaternary substituted bleach activators, are described in U.S. Pat. No. 6,855,680.

Another embodiment is to use in ones of the phases Organic Peroxides such as Diacyl Peroxides that do not cause visible spotting or filming are particularly preferred. One example is dibenzoyl peroxide. Other suitable examples are illustrated in Kirk Othmer, Encyclopedia of Chemical Technology at 27-90, v. 17, John Wiley and Sons, (1982).

Another embodiment of this invention is that one of the phases may contain a bleach catalyst such as:

a) Metal-containing Bleach Catalysts: Preferred bleach catalysts include manganese and cobalt-containing bleach catalysts. Other suitable metal-containing bleach catalysts include catalyst systems comprising a transition metal cation of defined bleach catalytic activity, such as copper, iron, titanium, ruthenium tungsten, molybdenum, or manganese cations; an auxiliary metal cation having little or no bleach catalytic activity, such as zinc or aluminum cations; and a sequestrate having defined stability constants for the catalytic and auxiliary metal cations, particularly ethylenediaminetetraacetic acid, ethylenediaminetetra (methylenephosphonic acid) and water-soluble salts thereof. Suitable catalyst systems are disclosed in U.S. Pat. No. 4,430,243 or
b) Transition Metal Complexes of Macropolycyclic Rigid Ligands: The fluid detergent compositions herein may also include bleach catalysts comprising a transition metal complex of a macropolycyclic rigid ligand. The amount used is preferably more than 1 ppb, more preferably 0.001 ppm or more, even more preferably from 0.05 ppm to 500 ppm (wherein “ppb” denotes parts per billion by weight and “ppm” denotes parts per million by weight).

### Or

c) Other Bleach Catalysts: Other bleach catalysts such as organic bleach catalysts and cationic bleach catalysts are suitable for the fluid detergent compositions of the invention. Organic bleach catalysts are often referred to as bleach boosters. The fluid detergent compositions herein may comprise one or more organic bleach catalysts to improve low temperature bleaching. Preferred organic bleach catalysts are zwitterionic bleach catalysts, including aryliminium zwitterions. Suitable examples include 3-(3,4-dihydroisoquinolinium) propane sulfonate and 3,4-dihydro-2-[2-(sulfooxy)decyl]isoquinolimium. Suitable aryliminium zwitterions include:

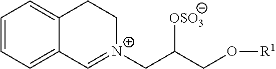

wherein R1 is a branched alkyl group containing from 9 to 24 carbons or linear alkyl group containing from 11 to 24 carbons. Preferably, each R1 is a branched alkyl group containing from 9 to 18 carbons or linear alkyl group containing from 11 to 18 carbons, more preferably each R1 is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other suitable examples of organic bleach catalysts can be found in U.S. Pat. No. 5,576,282 and U.S. Pat. No. 5,817,614, EP 923,636 B1, WO 2001/16263 A1, WO 2000/42156 A1, WO 2007/001262 A1. Suitable examples of cationic bleach catalysts are described in U.S. Pat. No. 5,360,569, U.S. Pat. No. 5,442,066, U.S. Pat. No. 5,478,357, U.S. Pat. No. 5,370,826, U.S. Pat. No. 5,482,515, U.S. Pat. No. 5,550,256, WO 95/13351, WO 95/13352, and WO 95/13353.

A preferred embodiment of the present invention is that one of the phases may contain a preformed peracid. In one embodiment, the preformed peracid is phthalimido peroxycaproic acid (PAP). Other suitable preformed peracids include, but are not limited to, compounds selected from the group consisting of: percarboxylic acids and salts, percarbonic acids and salts, perimidic acids and salts, peroxymonosulfuric acids and salts, and mixtures thereof. In compositions such as bleach containing fluid detergents, the preformed peracid may be present at a level of from 0.1% to 25%, preferably from 0.5% to 20%, more preferably from 1% to 10%, most preferably from 2% to 4% by weight of the composition. Alternatively, higher levels of peracid may be present. For instance, compositions such as fluid laundry bleach additives may comprise from 10% to 40%, preferably from 15% to 30%, more preferably from 15% to 25% by weight preformed peracid.

### Antibacterial Actives:

In another embodiment of this present invention the benefit phase might also comprise an antibacterial agent. An antibacterial agent is a chemical substance or microorganism which can deter, render harmless, or exert a controlling effect on any harmful organism by chemical or biological means. The choice of disinfectant to be used depends on the particular situation. Some disinfectants have a wide spectrum (kill many different types of microorganisms), while others kill a smaller range of disease-causing organisms but are preferred for other properties (they may be non-corrosive, non-toxic, or inexpensive). Within Western Europe the antibacterial actives that can be used in detergent applications are classified within the “Biocidal Products Directive 98/8/EC (BPD”), more particularly within “MAIN GROUP 1: Disinfectants and general biocidal products—Product-type 2: Private area and public health area disinfectants and other biocidal products”. Within North America antibacterial products and actives that can be used are regulated by the FDA and EPA. Potentially the antibacterial actives can be combined with antibacterial efficacy boosting technologies, especially chelants, or could be bound to a deposition polymer to deliver a long lasting disinfection efficacy.

Typical chemistry classes with illustrating examples being used demonstrating intrinsic antibacterial activity include but are not limited to alcohols (ethanol, methanol, propanol, isopropanol, benzyl alcohol, phenoxyethanol and bronopol), aldehydes (formaldehyde, glutaraldehyde, ortho-phtalaldehyde), Organic and Inorganic acids (lactic acid, citric acid, benzoic acid, salicylic acid, dehydroacetic acid, sulphur dioxide, sulphites, bisulphites, vanillic acid esters), hydrotropes (sodium cumene sulphonate, sodium xylene sulphonate, sodium toluene sulphonate), chlorine and oxygen based oxidizing agents (sodium and calcium hypochlorite or hypobromite, chloramine and chloramine-T, chlorine dioxide, hydrogen peroxide, iodine, ozone, peracetic acid, performic acid, potassium permanganate, potassium peroxymonosulfate), phenolics (phenol, o-phenylphenol, chloroxylenol, hexachlorophene, thymol, amylmetacresol, 2,4-dichlorobenzyl alcohol, policresylen, fentichlor, 4-allylcatechol, p-hydroxybenzoic acid esters including benzylparaben, butylparaben, ethylparaben, methtlparaben and propylparaben, butylated hydroxyanisole, butylated hydroxytoluene, capaicin, carvacrol, creosol, eugenol, guaiacol), halogenated diphenylethers (diclosan, triclosan, hexachlorophene and bromochlorophene, 4-hexylresorcinol, 8-hydroxyquinoline and salts thereof), quaternary ammonium compounds (benzalkonium chloride derivatives, benzethonium chloride derivatives, cetrimonium chloride/bromide, cetylpyridinium, cetrimide, benzoxonium chloride, didecyldimethyl ammonium chloride), acridine derivatives (ethacridine lactate, 9-aminoacridine, euflavine), biguanides and amidines (polyaminopropyl biguanide, dibrompropamidine, chlorhexidine, alexidine, propamidine, hexamidine, polihexanide), nitrofuran derivatives (nitrofurazone), quinoline derivatives (dequalinium, chlorquinaldol, oxyquinoline, clioquinol), iodine products, mercurial products, essential oils (bay, cinnamon, clove, thyme, eucalyptus, peppermint, lemon, tea tree, magnolia extract, menthol, geraniol), Heavy Metal derivatives (Silver Compounds e.g. Silver, Silver dihydrogen citrate, silver nitrate, Copper compounds e.g. copper (II) chloride, fluoride, sulfate and hydroxide, mercury compounds e.g. mercurochrome, nitromersol, thiomersal, phenylmercuric nitrate, phenylmercuric acetate, Tin and its compounds, titanium), Anilides (saclicylanilide, Diphenylureas), cations (organic and inorganic salts of Hg2+, Cu2+, Pb2+), salicylic acid esters including menthyl salicylate, methyl salicylate and phenyl salicylate, pyrocatechol, phtalic acid and salts thereof, hexetidine, octenidine, sanguinarine, domiphen bromide, alkylpyridinium chlorides such as cetylpyridinium chloride, tetradecylpyridinium chloride and N-tetradecyl-4-ethylpyridinium chloride, iodine, sulfonamides, piperidino derivatives such as delmopinol and octapinol, and mixtures thereof, miscellaneous preservatives (derivatives of 1,3-dioxane, derivatives of imidazole, Isothizolones, derivatives of hexamine, triazines, oxazolo-oxazoles, sodium hydroxymethylglycinate, methylene bisthiocyanate, captan).

### Malodor Compounds

In another embodiment of the present invention the composition might also comprise malodor control agents, selected from but not limited to the group of antibacterial agents, Zn salts, alfa-ionone, counter-act technologies and cyclodextrines and alike.

### The Pearlescent Agent

In another embodiment of the present invention the benefit phase might also comprise a pearlescent agent. The pearlescent agents according to the present invention can be crystalline or glassy solids, transparent or translucent compounds capable of reflecting and refracting light to produce a pearlescent effect. Typically, the pearlescent agents are crystalline particles insoluble in the composition in which they are incorporated. Preferably the pearlescent agents have the shape of thin plates or spheres. Particle size is measured across the largest diameter of the sphere. Plate-like particles are such that two dimensions of the particle (length and width) are at least 5 times the third dimension (depth or thickness). Other crystal shapes like cubes or needles or other crystal shapes do not display pearlescent effect. Many pearlescent agents like mica are natural minerals having monoclinic crystals. Shape appears to affect the stability of the agents. The spherical, even more preferably, the plate-like agents being the most successfully stabilised. Particle size of the pearlescent agent is typically below 200 microns, preferably below 100 microns, more preferably below 50 microns.

In one preferred embodiment of the present invention, the particles are randomly oriented throughout the liquid so that they scatter light from incoming angles, giving a constant pearlescent look independent of the angle from which the sample is observed. Alternatively, particles could also be ordered in the same direction to obtain a different light scattering profile and therefore provide a look dependent upon the angle through which the sample is observed.

The compositions of the present invention comprise from 0.005% to 3.0% wt, preferably from 0.01% to 1%, by weight of the composition of the 100% active pearlescent agents. The pearlescent agents may be organic or inorganic. The composition can comprise organic and/or inorganic pearlescent agent.

### Organic Pearlescent Agents:

When the composition of the present invention comprise an organic pearlescent agent, it is comprised at an active level of from 0.05% to 2.0% wt, preferably from 0.1% to 1.0% by weight of the composition of the 100% active organic pearlescent agents. Suitable organic pearlescent agents include monoester and/or diester of alkylene glycols having the formula:

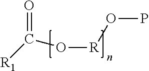

wherein R₁ is linear or branched C12-C22 alkyl group;
R is linear or branched C2-C4 alkylene group;
P is selected from H, C1-C4 alkyl or —COR₂, R₂ is C4-C22 alkyl, preferably C12-C22 alkyl; and n=1-3.

In one embodiment, the long chain fatty ester has the general structure described above, wherein R₁ is linear or branched C16-C22 alkyl group, R is —CH₂—CH₂—, and P is selected from H, or —COR₂, wherein R₂ is C4-C22 alkyl, preferably C12-C22 alkyl.

Typical examples are monoesters and/or diesters of ethylene glycol, propylene glycol, diethylene glycol, dipropylene glycol, triethylene glycol or tetraethylene glycol with fatty acids containing from about 6 to about 22, preferably from about 12 to about 18 carbon atoms, such as caproic acid, caprylic acid, 2-ethyhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, arachic acid, gadoleic acid, behenic acid, erucic acid, and mixtures thereof.

In one embodiment, ethylene glycol monostearate (EGMS) and/or ethylene glycol distearate (EGDS) and/or polyethylene glycol monostearate (PGMS) and/or polyethyleneglycol distearate (PGDS) are the pearlescent agents used in the composition. There are several commercial sources from these materials. For Example, PEG6000MS® is available from Stepan, Empilan EGDS/A® is available from Albright & Wilson.

In another embodiment, the pearlescent agent comprises a mixture of ethylene glycol diester/ethylene glycol monoester having the weight ratio of about 1:2 to about 2:1. In another embodiment, the pearlescent agent comprising a mixture of EGDS/EGMS having the weight ratio of about 60:40 to about 50:50 is found to be particularly stable in water suspension.

Co-Crystallizing Agents: Optionally, co-crystallizing agents are used to enhance the crystallization of the organic pearlescent agents such that pearlescent particles are produced in the resulting product. Suitable co-crystallizing agents include but are not limited to fatty acids and/or fatty alcohols having a linear or branched, optionally hydroxyl substituted, alkyl group containing from about 12 to about 22, preferably from about 16 to about 22, and more preferably from about 18 to 20 carbon atoms, such as palmitic acid, linoleic acid, stearic acid, oleic acid, ricinoleic acid, behenyl acid, cetearyl alcohol, hydroxystearyl alcohol, behenyl alcohol, linolyl alcohol, linolenyl alcohol, and mixtures thereof. In one embodiment where the co-crystallizing agent is present, the composition comprises 1-5 wt % C12-C20 fatty acid, C12-C20 fatty alcohol, or mixtures thereof. In another embodiment, the weight ratio between the organic pearlescent agent and the co-crystallizing agent ranges from about 3:1 to about 10:1, or from about 5:1 to about 20:1. A preferred method of incorporating organic pearlescent agents into a composition is to use a pre-crystallized organic pearlescent dispersion, named as “cold pearl”. A number of cold pearls are commercially available. These include trade names such as Stepan, Pearl-2 and Stepan Pearl 4 (produced by Stepan Company Northfield, Ill.), Mackpearl 202, Mackpearl 15-DS, Mackpearl DR-104, Mackpearl DR-106 (all produced by McIntyre Group, Chicago, Ill.), Euperlan PK900 Benz-W and Euperlan PK 3000 AM (produced by Cognis Corp).

### Inorganic Pearlescent Agents:

In another embodiment of the present invention the benefit phase might also comprise an inorganic pearlescent agent. When the composition of the present invention comprise an inorganic pearlescent agent, it is comprised at an active level of from 0.005% to 1.0% wt, preferably from 0.01% to 0.2% by weight of the composition of the 100% active inorganic pearlescent agents.

Inorganic pearlescent agents include aluminosilicates and/or borosilicates. Preferred are the aluminosilicates and/or borosilicates which have been treated to have a very high refractive index, preferably silica, metal oxides, oxychloride coated aluminosilicate and/or borosilicates. More preferred inorganic pearlescent agent is mica, even more preferred titanium dioxide treated mica such as BASF Mearlin Superfine.

It is preferable to use a pearlescent pigment with a high refractive index in order to keep the level of pigment at a reasonably low level in the formulation. Hence the pearlescent agent is preferably chosen such that it has a refractive index of more than 1.41, more preferably more than 1.8, even more preferably more than 2.0. Preferably the difference in refractive index between the pearlescent agent and the composition or medium, to which pearlescent agent is then added, is at least 0.02. Preferably the difference in refractive index between the pearlescent agent and the composition is at least 0.2, more preferably at least 0.6.

One preferred embodiment is metal oxide treated mica such as titanium oxide treated mica with a titanium oxide thickness from 1 nm to 150 nm, preferentially from 2 to 100 more preferentially from 5 to 50 nm to produce a silvery iridescence or from 50 nm to 150 nm produce colors that appear bronze, copper, red, red-violet or red-green. Gold iridescence could be obtained by applying a layer of iron oxide on top of a layer of titanium oxide. Typical interference pigment function of the thickness of the metal oxide layer could be found in scientific literature.

Other commercially available suitable inorganic pearlescent agents are available from Merck under the tradenames Iriodin, Biron, Xirona, Timiron Colorona, Dichrona, Candurin and Ronastar. Other commercially available inorganic pearlescent agent are available from BASF (Engelhard, Meanl) under tradenames Biju, B1-Lite, Chroma-Lite, Pearl-Glo, Mearlite and from Eckart under the tradenames Prestige Soft Silver and Prestige Silk Silver Star.

### Suspension Particles

In one embodiment, the liquid detergent compositions further comprises a plurality of suspension particles at a level of from about 0.01% to about 5% by weight, alternatively from about 0.05% to about 4% by weight, alternatively from about 0.1% to about 3% by weight. Examples of suitable suspension particles are provided in U.S. Pat. No. 7,169,741 and U.S. Patent Publ. No. 2005/0203213, the disclosures of which are incorporated herein by reference. These suspended particles can comprise a liquid core or a solid core. Detailed description of these liquid core and solid core particles, as well as description of preferred particle size, particle shape, particle density, and particle burst strength are described in U.S. patent application Ser. No. 12/370,714, the disclosure of which is incorporated herein by reference.

In one preferred embodiment, the particles may be any discrete and visually distinguishable form of matter, including but not limiting to (deformable) beads, encapsulates, polymeric particles like plastic, metals (e.g. foil material, flakes, glitter), (interference) pigments, minerals (salts, rocks, pebbles, lava, glass/silica particles, talc), plant materials (e.g pits or seeds, plant fibers, stalks, stems, leaves or roots), solid and liquid crystals, and the like. Different particle shapes are possible, ranging from spherical to tabular.

In one embodiment of the present invention, the suspension particles may be gas or air bubbles. In this embodiment, the diameter of each bubble may be from about 50 to about 2000 microns and may be present at a level of about 0.01 to about 5% by volume of the composition alternatively from about 0.05% to about 4% by volume of the composition, alternatively from about 0.1% to about 3% by volume of the composition. In yet another embodiment of the present invention, the bubbles may be present in one of the phase of the composition. In other embodiment of the present invention, the bubbles may be present in at least two phases of the composition.

Many different techniques have been devised for determining particle size distribution in liquid compositions, but for a wide range of industries laser based analytical method diffraction has become the preferred choice. For example, laser diffraction, alternatively referred to as Low Angle Laser Light Scattering (LALLS), can be used for the non-destructive analysis of wet or dry samples, with particles in the size range 0.02 to 2000 micron. Alternatively online droplet sizing systems capture high-speed images of bubble stream to give the drop size. In addition to measuring the particle diameter distribution, lasers imaging systems also provide real-time shape and velocity analysis.

Laser diffraction based particle size analysis relies on the fact that particles passing through a laser beam will scatter light at an angle that is directly related to their size. As particle size decreases, the observed scattering angle increases logarithmically. Scattering intensity is also dependent on particle size, diminishing with particle volume. Large particles therefore scatter light at narrow angles with high intensity whereas small particles scatter at wider angles but with low intensity. It is this behavior that instruments based on the technique of laser diffraction exploit in order to determine particle size. A typical system consists of a laser, to provide a source of coherent, intense light of fixed wavelength; a series of detectors to measure the light pattern produced over a wide range of angles; and some kind of sample presentation system to ensure that material under test passes through the laser beam as a homogeneous stream of particles in a known, reproducible state of dispersion.

### Perfume Microcapsules

In one embodiment, the perfume comprises a perfume microcapsule and/or a perfume nanocapsule. Suitable perfume microcapsules and perfume nanocapsules include those described in the following references: US 2003215417 A1; US 2003216488 A1; US 2003158344 A1; US 2003165692 A1; US 2004071742 A1; US 2004071746 A1; US 2004072719 A1; US 2004072720 A1; EP 1393706 A1; US 2003203829 A1; US 2003195133 A1; US 2004087477 A1; US 20040106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32713; U.S. Pat. No. 4,234,627, the disclosures of which are incorporated herein by reference.

In yet another embodiment, the liquid detergent composition comprises odor control agents such as described in U.S. Pat. No. 5,942,217: “Uncomplexed cyclodextrin compositions for odor control”, granted Aug. 24, 1999. Other agents suitable odor control agents include those described in: U.S. Pat. No. 5,968,404, U.S. Pat. No. 5,955,093; U.S. Pat. No. 6,106,738; U.S. Pat. No. 5,942,217; and U.S. Pat. No. 6,033,679, the disclosures of which are incorporated herein by reference.

### Other Components:

The cleaning phase and/or benefit phase of the multiphase hand dishwashing liquid detergent compositions herein can further comprise a number of other components suitable for use in liquid detergent compositions such as perfume, colorants, opacifiers, organic and inorganic cations such as alkaline earth metals such as Ca/Mg-ions and diamines, solvents, hydrotropes, suds stabilizers/boosters, anti-caking agents, viscosity trimming agents (e.g. salt such as NaCl and other mono-, di- and trivalent salts), preservatives and pH trimming and/or buffering means (e.g. carboxylic acids such as citric acid, HCl, NaOH, KOH, amines and alkanolamines, phosphoric and sulfonic acids, carbonates such as sodium carbonates, bicarbonates, sesquicarbonates, borates, silicates, phosphates, imidazole and alike).

### Colorant:

In one embodiment of the present invention the cleaning and/or benefit phase might also comprise a colorant. Advantageously, using a colorant in accordance with the present invention gives a visual effect between the multiple phases and provides consumers with a pleasing visual experience.

As the term is used herein a “colorant” can be either a pigment or a dye depending on the vehicle in which it is used. In some embodiments of the present invention, a pigment can be manufactured from a dye by precipitating a soluble dye with a metallic salt. The resulting pigment is called herein a lake pigment. In addition, it is generally accepted that there is a distinction usually made between a pigment, which is insoluble in the vehicle (resulting in a suspension), and a dye, which either is itself a liquid or is soluble in its vehicle (resulting in a solution). The term “biological pigment” is used herein for all colored substances independent of their solubility.

As the term is used herein a “pigment” is a material that changes the color of reflected light or transmitted of the phase. Such pigment can be natural, such as ultramarine blue, or synthetic, such as synthetic ultramarine pigment which is chemically identical to natural ultramarine. In one embodiment of the present invention, the pigment can be in powdered form. Preferred pigments are chemically inert and stable to UV, but fugitive pigment could be used to provide a color shift of the phases. Preferred pigments of this invention can be inorganic, organic or special pigments.

Naturally occurring pigments have been used as colorants since prehistoric times. In one embodiment of the present invention, the pigment can be a natural pigment, such as mica. In yet another embodiment of the present invention, pigments from unusual sources such as botanical materials, animal waste, insects, and mollusks can be used.

In accordance with another embodiment of the present invention, the pigment may be inorganic. Preferred inorganic pigments are the FDA approved pigment such as Blue 29 ultramarine, white 6 titanium oxide and white 18 calcium carbonate. Preferred organic pigments are FDA approved pigments such as blue 15 phthalocyanine and red 38 pyrazolone. In one embodiment of the present invention, inorganic food grade pigments such as E180, E171 and E172 and organic food grade pigment such as turmeric pigment may be used.

In yet another embodiment of the present invention, the colorant can be a dye. It is generally accepted that suitable dyes could be natural or synthetic. As the term is used herein a “dye” is a colored substance that has an affinity to the substrate to which it is being applied. Acid dyes and more specifically synthetic food colors fall from this category are relevant to the present invention. Basic dyes are water-soluble cationic dyes, possibly complexed to anionic surfactant or polymers are also preferred for the present invention. When used direct dye could provide to the invention additional benefit as they are used as pH indicators.

In one preferred embodiment, the dye can be selected from the group consisting of D&C Red 7; Red 57; Red 122; Red 405, 48:2; Red 206, 11, 49:2; Red 7, Red f4rh; Red 181, Red 226; Red B, Red 3, toluidine Red XL; Red 4, natural Red 4; Red 4, carmine; Red 150, Red 213, Red 4134; Solvant Red 139; Solvant Red 119; Natural yellow 5, curcumin; Pigment yellow 83; Iron pigment yellow 42, pigment 43; Japan yellow 201; Blue 15; Blue 66, blue 1, blue 6; Blue 29, ultramarine; Food Blue 4, blue 60; and mixtures thereof.

Water insoluble dyes are preferred to maintain the perfect stability of the color in between the multiphase product. Preferred non water soluble dyes are Vat dyes are essentially insoluble in water and in acidic conditions. Disperse dyes were originally developed for the dyeing of cellulose acetate, and are water insoluble.

Reactive and azoic dyes are also encompassed in this present invention, specifically if they are applied to micro/nano cellulosic matter or applied on non water soluble particles.

Most preferred are polymeric dyes. It is generally accepted that polymeric dyes are composed of optically chromophoric groups bound to or into polymers. They are classified as block type and graft type according to their structures. Either block polymeric dyes or graft polymeric dyes offer the advantage of allowing a range of physical properties, such as solubility, absorption, migration and viscosity that are tunable. The range of products possible offered by the joining of the fields of polymer chemistry and color chemistry is virtually inexhaustible. Polymeric water-soluble dyes, which are of considerable biological and technological interest because of their various properties including limited transfer from phase to phase. In addition they are generally described of being non absorbable.

To prepare water-soluble polymeric dyes constructed of fundamentally water-insoluble chromophores, the chromophore must somehow be attached to, or be made a part of, a polymeric system which otherwise contains the required solubilizing functionality.

Preferred polymeric dye have pendent chromophore groups which are selected from azo, tricyanovinyl, anthraquinone, methine, and indoaniline groups.

### Opacifier

In one embodiment of the present invention the cleaning and/or benefit phase might also comprise an opacifier. As the term is used herein, an “opacifier” is a substance added to a material in order to make the ensuing system opaque. In one preferred embodiment, the opacifier is Acusol, which is available from Dow Chemicals. Acusol opacifiers are provided in liquid form at a certain % solids level. As supplied, the pH of Acusol opacifiers ranges from 2.0 to 5.0 and particle sizes range from 0.17 to 0.45 um. Acusol OP303B and 301 opacifiers are a water-based, styrene/acrylamide emulsion used for opacifying household and institutional products including laundry and dishwash detergents and household cleaners

In yet another embodiment, the opacifier may be an inorganic opacifier. Preferably, the inorganic opacifier can be TiO₂, ZnO, talc, CaCo₃, and combination thereof. The composite opacifier-microsphere material is readily formed with a preselected specific gravity, so that there is little tendency for the material to separate.

### Magnesium Ions

When utilized in either the cleaning phase and/or separate benefit phase, the magnesium ions preferably are added as a hydroxide, chloride, acetate, sulphate, formate, oxide or nitrate salt to the compositions of the present invention, typically at an active level of from 0.01% to 1.5%, preferably from 0.015% to 1%, more preferably from 0.025% to 0.5%, by weight of the total composition.

### Diamines

Another optional ingredient of the cleaning phase and/or separate benefit phase according to the present invention is a diamine. Since the habits and practices of the users of liquid detergent compositions show considerable variation, the composition will preferably contain 0% to 15%, preferably 0.1% to 15%, preferably 0.2% to 10%, more preferably 0.25% to 6%, more preferably 0.5% to 1.5% by weight of said composition of at least one diamine.

Preferred organic diamines are those in which pK1 and pK2 are in the range of 8.0 to 11.5, preferably in the range of 8.4 to 11, even more preferably from 8.6 to 10.75. Preferred materials include 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (DYTEK EP®)) (pK1=10.5; pK2=8.9), 2-methyl 1,5 pentane diamine (DYTEK A®)) (pK1=11.2; pK2=10.0). Other preferred materials include primary/primary diamines with alkylene spacers ranging from C₄ to C₈. In general, it is believed that primary diamines are preferred over secondary and tertiary diamines. pKa is used herein in the same manner as is commonly known to people skilled in the art of chemistry: in an all-aqueous solution at 25° C. and for an ionic strength between 0.1 to 0.5 M. Values referenced herein can be obtained from literature, such as from “Critical Stability Constants: Volume 2, Amines” by Smith and Martel, Plenum Press, NY and London, 1975.

### Organic Solvents

The present compositions may optionally comprise an organic solvent. Suitable organic solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. In one embodiment, the liquid detergent composition comprises from about 0.0% to less than 50% of a solvent. When present, the liquid detergent composition will contain from about 0.01% to about 20%, alternatively from about 0.5% to about 15%, alternatively from about 1% to about 10% by weight of the liquid detergent composition of said organic solvent. These organic solvents may be used in conjunction with water, or they may be used without water.

### Hydrotrope

The liquid detergent compositions optionally comprises a hydrotrope in an effective amount, i.e. from about 0% to 15%, or about 1% to 10%, or about 3% or about 6%, so that the liquid detergent compositions are compatible in water. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, as disclosed in U.S. Pat. No. 3,915,903.

### Polymeric Suds Stabilizer

The liquid detergent compositions of the present invention may optionally contain a polymeric suds stabilizer at a level from about 0.01% to about 15%. These polymeric suds stabilizers provide extended suds volume and suds duration of the liquid detergent compositions. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from about 1,000 to about 2,000,000, alternatively from about 5,000 to about 1,000,000, alternatively from about 10,000 to about 750,000, alternatively from about 20,000 to about 500,000, alternatively from about 35,000 to about 200,000. The polymeric suds stabilizer can optionally be present in the form of a salt, either an inorganic or organic salt, for example the citrate, sulfate, or nitrate salt of (N,N-dimethylamino)alkyl acrylate ester.

One suitable polymeric suds stabilizer is (N,N-dimethylamino)alkyl acrylate esters, namely the acrylate ester represented by the following formula:

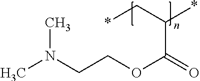

When present in the liquid detergent compositions, the polymeric suds booster may be present in the liquid detergent composition from about 0.01% to about 15%, alternatively from about 0.05% to about 10%, alternatively from about 0.1% to about 5%, by weight of the liquid detergent composition.

### Incompatible or Reactive Materials:

In one embodiment of the present invention, incompatible or reactive materials are distributed amongst the multiple liquid phases, such that the chemical and/or physical stability of the materials is maintained, to prevent problems with physical separation of the materials, or a desired active is generated upon use.

Non-limiting examples where phase separation is desired for chemical stability of the desired materials are enzymes combined with anionic surfactants and/or bleach and/or alkaline pH, dyes/perfumes with bleach and/or alkaline pH, or prevention of SCHIFF base browning reactions through separating aldehydes from amines.

Non-limiting examples where phase separation is desired to prevent problems with physically separating the materials are anionic and cationic compounds such as surfactants, polymers or salts, and multi surfactant aggregate phases such as isotropic and microemulsion surfactant mixture.

Non-limiting examples where a desired active is generated upon use are bleach generation through bleach activator and hydrogen peroxide, bleach activators and pH, or bleaching enzymes and substrate combinations such as glucose oxidase and glucose, and inducing fizzing reactions through combining carbonate and acidic pH. In one embodiment, the multiple liquid phases might comprise different perfume compositions which upon mixing deliver the targeted perfume experience. In another embodiment, the multi-liquid phases can be constructed such that only one phase gets dosed at a time and therefore causing different perfume experience to be delivered upon multiple uses, preventing perfume habituation. In yet another embodiment, an active comprising a perfume and an active deposition aid comprising a perfume deposition aid, which itself comprises a perfume depositing polymer, can also be split over the multiple phases.

### Packaging:

The liquid detergent compositions of the present invention may be packed in any suitable packaging for delivering the liquid detergent composition for use. Preferably, the package is a transparent or translucent package made of glass or plastic so that consumers can see the pattern throughout the packaging. In one preferred embodiment, the package may be comprised of polyethylene terephthalate, high-density polyethylene, low-density polyethylene, or combinations thereof. Furthermore, preferably, the package may be dosed through a cap at the top of the package such that the composition exits the bottle through an opening in the cap. In one embodiment, the opening in the cap may also contain a screen to help facilitate dosing. In yet another embodiment, the package may be dosed through a cap at the bottom of the package to help minimize the risk of consumers affecting the aesthetic appeal of the multiphase composition in the package.

### The Process of Cleaning/Treating a Dishware

Another embodiment of the present invention is directed to a process of cleaning dishware with a composition of the present invention. Yet another embodiment of the present invention is directed to a process of cleaning dishware with a multiphase liquid composition comprising at least two cleaning phase and at least one separate benefit phase, a surfactant and a crystalline structurant present in both the at least two cleaning phase. Said processes comprises the step of applying the composition onto the dishware surface, typically in diluted or neat form and rinsing or leaving the composition to dry on the surface without rinsing the surface.

By “in its neat form”, it is meant herein that said liquid composition is applied directly onto the surface to be treated and/or onto a cleaning device or implement such as a dish cloth, a sponge or a dish brush without undergoing any dilution at 0 gpg water hardness by the user (immediately) prior to the application. By “diluted form”, it is meant herein that said liquid composition is diluted by the user with an appropriate solvent, typically water. By “rinsing”, it is meant herein contacting the dishware cleaned with the process according to the present invention with substantial quantities of appropriate solvent, typically water, after the step of applying the liquid composition herein onto said dishware. By “substantial quantities”, it is meant usually about 5 to about 20 liters.

In one embodiment of the present invention, the composition herein can be applied in its diluted form. Soiled dishes are contacted with an effective amount, typically from about 0.5 ml to about 20 ml (per about 25 dishes being treated), preferably from about 3 ml to about 10 ml, of the liquid detergent composition of the present invention diluted in water. The actual amount of liquid detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from about 0.01 ml to about 150 ml, preferably from about 3 ml to about 40 ml of a liquid detergent composition of the invention is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of the present invention will comprise immersing the soiled dishes into a water bath or held under running water without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Alternatively, the device may be immersed in a mixture of the hand dishwashing composition and water prior to being contacted with the dish surface, the concentrated solution is made by diluting the hand dishwashing composition with water in a small container that can accommodate the cleaning device at weight ratios ranging from about 95:5 to about 5:95, preferably about 80:20 to about 20:80 and more preferably about 70:30 to about 30:70, respectively, of hand dishwashing liquid:water respectively depending upon the user habits and the cleaning task.

Dependent on the geography of use of the composition, the water used in the method of the present invention can have a hardness level of about 0-30 gpg (“gpg” is a measure of water hardness that is well known to those skilled in the art, and it stands for “grains per gallon”).

### Examples

| Finished Product | Ex. 1 | Ex. 1 | Ex. 2 | Ex. 2 | Ex. 3 | Ex. 3 | Ex. 4 | Ex 4 |
|---|---|---|---|---|---|---|---|---|
| Material Chemical Name | phase A | Phase B | Phase A | Phase B | Phase A | Phase B | Phase A | Phase B |
| % of Phases in Finish | 50 | 50 | 10 | 90 | 50 | 50 | 10 | 90 |
| Product | | | | | | | | |
| Cellulon PX | 0.1 | 0.1 | 0.1 | 0.1 | 0.0 | 0.0 | 0.0 | 0.0 |
| Microfibrous Cellulose | | | | | | | | |
| Amido-Gellant | x | x | x | x | y | y | y | y |
| polyssacharides | 0.0 | 0.0 | 0.0 | 0.0 | 0.0 | 0.0 | 0.1 | 0.1 |
| Pigmosol Blue 6900 | 0.008 | 0.0 | 0.0 | 0.0 | 0.008 | 0.0 | 0.0 | 0.0 |
| Timica extra large | 0.000 | 0.0 | 0.0 | 0.0 | 0.000 | 0.1 | 0.0 | 0.0 |
| sparkle 110s | | | | | | | | |
| ISP Captivate white bead | 0.0 | 1.0 | 0.0 | 0.0 | 1.0 | 0.0 | 0.0 | 0.0 |
| Euperlan WUL | 0.0 | 0.0 | 0.0 | 0.0 | 0.0 | 0.0 | 0.0 | 2.0 |
| Biron Silver CO | 0.0 | 0.0 | 0.2 | 0.0 | 0.0 | 0.0 | 0.0 | 0.0 |
| Iriodin 355 Glitter Gold - | 0.0 | 0.0 | 0.0 | 0.1 | 0.0 | 0.0 | 0.1 | 0.0 |
| Mica | | | | | | | | |
| NaOH (50%) | 0.3 | 0.3 | 0.3 | 0.3 | 0.3 | 0.3 | 0.3 | 0.3 |
| NaCl, (100%) | 1.0 | 1.0 | 1.0 | 1.0 | 0.5 | 0.5 | 1.0 | 1.0 |
| MgCl2 | 0.1 | 0.0 | 0.1 | 0.1 | 0.1 | 0.0 | 0.1 | 0.1 |
| Lial 123A sulfate | 8.0 | 8.0 | 4.0 | 4.0 | 8.0 | 8.0 | 5.0 | 5.0 |
| C12-C13 E3 ethoxylated | 8.0 | 8.0 | 4.0 | 4.0 | 8.0 | 8.0 | 5.0 | 5.0 |
| sulfate | | | | | | | | |
| Shell A sulfate | 8.0 | 8.0 | 4.0 | 4.0 | 8.0 | 8.0 | 5.0 | 5.0 |
| C12-C14 Amine Oxide | 5.0 | 5.0 | 5.0 | 5.0 | 5.0 | 5.0 | 6.0 | 6.0 |
| Polypropylene glycol | 0.1 | 0.1 | 0.0 | 0.0 | 0.3 | 0.3 | 0.1 | 0.1 |
| 2000, (100%) | | | | | | | | |
| Ethanol | 0.0 | 0.0 | 1.0 | 1.0 | 3.0 | 3.0 | 2.0 | 2.0 |
| Acticide M20 (MIT) | 0.008 | 0.008 | 0.008 | 0.008 | 0.008 | 0.008 | 0.008 | 0.008 |
| Phenoxyethanol | 0.2 | 0.2 | 0.2 | 0.2 | 0.2 | 0.2 | 0.2 | 0.2 |
| Perfume | 0.3 | 0.3 | 0.3 | 0.3 | 0.3 | 0.3 | 0.3 | 0.3 |
| TOTAL including | 100 | 100 | 100 | 100 | 100 | 100 | 100 | 100 |
| minors | | | | | | | | |
| Finished Product | Ex 5 | Ex 5 | Ex 6 | Ex 6 | Ex 7 | Ex 7 | Ex 8 | Ex 8 |
| Material Chemical Name | phase A | Phase B | Phase A | Phase B | phase A | Phase B | Phase A | Phase B |
| % of the Leg in Finish | 50 | 50 | 50 | 50 | 60 | 40 | 50 | 50 |
| Product | | | | | | | | |
| Cellulon PX | 0.1 | 0.1 | 0.1 | 0.1 | 0.1 | 0.1 | 0.1 | 0.1 |
| Microfibrous Cellulose | | | | | | | | |
| Pigmosol Blue 6900 | 0.008 | 0.0 | 0.0 | 0.0 | 0.0 | 0.0 | 0.0 | 0.0 |
| FD&C Yellow No. 5 | 0.0 | 0.0 | 0.0 | 0.0 | 20 ppm | 20 ppm | 40 ppm | 40 ppm |
| FD&C Blue No. 1 | 0.0 | 0.0 | 16 ppm | 16 ppm | 0.000 | 0.0 | 16 ppm | 16 ppm |
| Acusol OP 301 | 0.0 | 0.0 | 0.0 | 0.8 | 0.0 | 0.0 | 0.0 | 0.0 |
| ISP Captivate white bead | 0.0 | 0.0 | 0.0 | 0.0 | 0.0 | 1.0 | 0.0 | 0.0 |
| Expanded Aegean perlite | 0.0 | 2.0 | 0.0 | 0.0 | 0.0 | 0.0 | 0.0 | 0.0 |
| Timica extra large | 0.0 | 0.0 | 0.0 | 0.0 | 0.0 | 0.0 | 0.0 | 0.1 |
| sparkle 110s | | | | | | | | |
| Biron Silver CO | 0.0 | 0.0 | 0.2 | 0.0 | 0.2 | 0.0 | 0.2 | 0.0 |
| Iriodin 355 Glitter Gold - | 0.0 | 0.0 | 0.0 | 0.1 | 0.0 | 0.1 | 0.0 | 0.1 |
| Mica | | | | | | | | |
| NaOH (50%) | 0.3 | 0.3 | 0.3 | 0.3 | 0.3 | 0.3 | 0.3 | 0.3 |
| NaCl, (100%) | 1.0 | 1.0 | 1.0 | 1.0 | 1.0 | 1.0 | 1.0 | 1.0 |
| MgCl2 | 0.1 | 0.0 | 0.1 | 0.1 | 0.1 | 0.1 | 0.1 | 0.1 |
| Lial 123A sulfate | 8.0 | 8.0 | 4.0 | 4.0 | 5.0 | 0.0 | 9.0 | 9.0 |
| C12-C13 3 ethoxylated | 8.0 | 8.0 | 4.0 | 4.0 | 5.0 | 0.0 | 9.0 | 9.0 |
| sulfate | | | | | | | | |
| Shell A sulfate | 8.0 | 8.0 | 4.0 | 4.0 | 5.0 | 0.0 | 9.0 | 9.0 |
| C12-C14 Amine Oxide | 5.0 | 5.0 | 5.0 | 5.0 | 6.0 | 7.0 | 6.0 | 6.0 |
| Alkyl poly glycoside | 0.0 | 0.0 | 0.0 | 0.0 | 0.0 | 0.0 | 0.0 | 0.0 |
| C9-11 EO8 nonionic | 0.0 | 0.0 | 0.0 | 0.0 | 0.0 | 7.0 | 0.0 | 0.0 |
| Polypropylene glycol | 0.0 | 0.0 | 0.0 | 0.0 | 0.0 | 0.0 | 0.1 | 0.1 |
| 2000, (100%) | | | | | | | | |
| ethanol | 4.0 | 4.0 | 4.0 | 4.0 | 4.0 | 4.0 | 4.0 | 4.0 |
| GLDA | 0.0 | 0.0 | 0.6 | 0.6 | 0.6 | 0.6 | 0.6 | 0.6 |
| C10 to C14 cationic | 0.0 | 0.0 | 0.0 | 0.0 | 0.0 | 3.0 | 0.0 | 0.0 |
| dimethylethanol quat | | | | | | | | |
| Acticide M20 (MIT) | 0.008 | 0.008 | 0.008 | 0.008 | 0.008 | 0.008 | 0.008 | 0.008 |
| Phenoxyethanol | 0.2 | 0.2 | 0.2 | 0.2 | 0.2 | 0.2 | 0.2 | 0.2 |
| Perfume | 0.3 | 0.3 | 0.3 | 0.3 | 0.3 | 0.3 | 0.3 | 0.3 |
| TOTAL including | 100 | 100 | 100 | 100 | 100 | 100 | 100 | 100 |
| minors | | | | | | | | |
| Finished Product | Ex 9 | Ex 9 | Ex 10 | Ex 10 | Ex11 | Ex 11 | Ex 12 | Ex12 |
| Material Chemical Name | phase A | Phase B | Phase A | Phase B | phase A | Phase B | Phase A | Phase B |
| % of the Leg in Finish | 50 | 50 | 50 | 50 | 50 | 50 | 50 | 50 |
| Product | | | | | | | | |
| Cellulon PX | 0.1 | 0.1 | 0.1 | 0.1 | 0.1 | 0.1 | 0.1 | 0.1 |
| Microfibrous Cellulose | | | | | | | | |
| Pigmosol Blue 6900 | 0.008 | 0.0 | 0.0 | 0.0 | 0.008 | 0.0 | 0.008 | 0.008 |
| FD&C Yellow No. 5 | 0.0 | 0.0 | 0.0 | 0.0 | 0.0 | 0.0 | 0.0 | 0.0 |
| FD&C Blue No. 1 | 0.0 | 0.0 | 16 ppm | 16 ppm | 0.0 | 0.0 | 0.0 | 0.0 |
| Acusol OP 301 | 0.0 | 0.0 | 0.0 | 0.0 | 0.0 | 0.0 | 0.0 | 0.0 |
| ISP Captivate white bead | 0.0 | 0.0 | 0.0 | 0.0 | 0.0 | 0.0 | 0.0 | 0.0 |
| Euperlan WUL | 0.0 | 0.0 | 0.0 | 2.0 | 0.0 | 0.0 | 0.0 | 0.0 |
| Expanded Aegean perlite | 0.0 | 2.0 | 0.0 | 0.0 | 0.0 | 0.0 | 0.0 | 0.0 |
| Timica extra large | 0.0 | 0.0 | 0.0 | 0.0 | 0.0 | 0.0 | 0.0 | 0.0 |
| sparkle 110s | | | | | | | | |
| Biron Silver CO | 0.0 | 0.0 | 0.2 | 0.0 | 0.0 | 0.0 | 0.0 | 0.0 |
| Iriodin 355 Glitter Gold - | 0.0 | 0.0 | 0.0 | 0.1 | 0.0 | 0.0 | 0.0 | 0.0 |
| Mica | | | | | | | | |
| NaOH (50%) | 0.3 | 0.3 | 0.3 | 0.3 | 0.3 | 0.3 | 0.3 | 0.3 |
| NaCl, (100%) | 1.0 | 1.0 | 1.0 | 1.0 | 1.0 | 1.0 | 1.0 | 1.0 |
| MgCl2 | 0.1 | 0.0 | 0.1 | 0.1 | 0.1 | 0.1 | 0.1 | 0.1 |
| Linear Alkylbenzene | 12.0 | 12.0 | 0.0 | 0.0 | 0.0 | 0.0 | 0.0 | 0.0 |
| sulfonate | | | | | | | | |
| Lial 123A sulfate | 0.0 | 0.0 | 4.0 | 4.0 | 9.0 | 10.0 | 9.0 | 2.0 |
| C12-C13 3 ethoxylated | 4.0 | 4.0 | 4.0 | 4.0 | 9.0 | 10.0 | 9.0 | 2.0 |
| sulfate | | | | | | | | |
| Shell A sulfate | 8.0 | 8.0 | 4.0 | 4.0 | 9.0 | 10.0 | 9.0 | 2.0 |
| C12-C14 Amine Oxide | 0.0 | 0.0 | 0.0 | 0.0 | 6.0 | 6.0 | 6.0 | 1.0 |
| cocoamido propyl | 0.0 | 0.0 | 5.0 | 5.0 | 0.0 | 0.0 | 0.0 | 0.0 |
| betaine | | | | | | | | |
| C9-11 EO8 nonionic | 8.0 | 8.0 | 1.0 | 1.0 | 0.0 | 0.0 | 0.0 | 0.0 |
| Polypropylene glycol | 0.5 | 0.5 | 0.0 | 0.0 | 1.0 | 0.0 | 1.0 | 1.0 |
| 2000, (100%) | | | | | | | | |
| ethanol | 4.0 | 4.0 | 2.0 | 2.0 | 2.0 | 8.0 | 2.0 | 2.0 |
| Sodium cumene | 0.0 | 0.0 | 0.0 | 0.0 | 0.0 | 2.0 | 0.0 | 0.0 |
| sulfonate | | | | | | | | |
| Solvay PAP particle | 0.0 | 0.0 | 0.0 | 0.0 | 0.0 | 0.0 | 0.0 | 5.0 |
| Acticide M20 (MIT) | 0.008 | 0.008 | 0.008 | 0.008 | 0.008 | 0.008 | 0.008 | 0.008 |
| Phenoxyethanol | 0.2 | 0.2 | 0.2 | 0.2 | 0.2 | 0.2 | 0.2 | 0.2 |
| Perfume | 0.3 | 0.3 | 0.3 | 0.3 | 0.3 | 0.3 | 0.3 | 0.3 |
| TOTAL including | 100 | 100 | 100 | 100 | 100 | 100 | 100 | 100 |
| minors | | | | | | | | |
| Finished Product | Ex 13 | Ex13 | Ex 14 | Ex 14 | Ex 15 | Ex 15 | Ex 16 | Ex 16 |
| Material Chemical Name | phase A | Phase B | Phase A | Phase B | phase A | Phase B | Phase A | Phase B |
| % of the Leg in Finish | 50 | 50 | 50 | 50 | 50 | 50 | 70 | 30 |
| Product | | | | | | | | |
| air bubble % in volume | 0 | 3 | 0 | 0 | 0 | 0 | 0 | 3 |
| Cellulon PX | 0.1 | 0.1 | 0.0 | 0.0 | 0.1 | 0.1 | 0.1 | 0.1 |
| Microfibrous Cellulose | | | | | | | | |
| Rockwood laponite XLG | 0.0 | 0.0 | 0.2 | 0.2 | 0.2 | 0.2 | 0.0 | 0.0 |
| Acylyn 88 polymer | 0.0 | 0.0 | 1.4 | 1.4 | 0.0 | 0.0 | 0.0 | 0.0 |
| Pigmosol Blue 6900 | 0.0 | 0.0 | 0.008 | 0.0 | 0.008 | 0.0 | 0.0 | 0.0 |
| FD&C Yellow No. 5 | 0.0 | 0.0 | 0.0 | 0.0 | 0.0 | 0.0 | 0.0 | 0.0 |
| FD&C Blue No. 1 | 16 ppm | 16 ppm | 0.000 | 0.0 | 0.0 | 0.0 | 16 ppm | 16 ppm |
| Acusol OP 301 | 0.0 | 0.0 | 0.0 | 0.0 | 0.0 | 0.0 | 0.0 | 0.0 |
| ISP Captivate white bead | 0.0 | 0.0 | 0.0 | 2.0 | 0.0 | 2.0 | 0.0 | 0.0 |
| petrolatum mineral oil | 0.0 | 0.0 | 0.0 | 0.0 | 0.0 | 15.0 | 0.0 | 0.0 |
| Euperlan WUL | 0.0 | 0.0 | 0.0 | 0.0 | 0.0 | 0.0 | 0.0 | 0.0 |
| Expanded Aegean perlite | 0.0 | 0.0 | 0.0 | 0.0 | 0.0 | 0.0 | 0.0 | 0.0 |
| Timica extra large | 0.0 | 0.0 | 0.0 | 0.0 | 0.0 | 0.0 | 0.0 | 0.0 |
| sparkle 110s | | | | | | | | |
| Biron Silver CO | 0.0 | 0.0 | 0.2 | 0.0 | 0.2 | 0.0 | 0.1 | 0.0 |
| Iriodin 355 Glitter Gold - | 0.0 | 0.0 | 0.0 | 0.1 | 0.0 | 0.0 | 0.0 | 0.1 |
| Mica | | | | | | | | |
| NaOH (50%) | 0.3 | 0.3 | 0.3 | 0.3 | 0.3 | 0.0 | 0.3 | 0.3 |
| NaCl, (100%) | 1.0 | 1.0 | 1.0 | 1.0 | 1.0 | 0.0 | 1.0 | 1.0 |
| MgCl2 | 0.1 | 0.1 | 0.1 | 0.1 | 0.1 | 0.1 | 0.1 | 0.1 |
| Linear Alkylbenzene | 0.0 | 0.0 | 0.0 | 0.0 | 0.0 | 0.0 | 0.0 | 0.0 |
| sulfonate | | | | | | | | |
| Lial 123A sulfate | 9.0 | 10.0 | 4.0 | 4.0 | 4.0 | 0.0 | 4.0 | 0.0 |
| C12-C13 3 ethoxylated | 9.0 | 10.0 | 4.0 | 4.0 | 4.0 | 0.0 | 4.0 | 0.0 |
| sulfate | | | | | | | | |
| Shell A sulfate | 9.0 | 10.0 | 4.0 | 4.0 | 4.0 | 0.0 | 4.0 | 0.0 |
| C12-C14 Amine Oxide | 6.0 | 6.0 | 0.0 | 0.0 | 0.0 | 0.0 | 5.0 | 0.0 |
| cocoamido propyl | 0.0 | 0.0 | 5.0 | 5.0 | 5.0 | 0.0 | 0.0 | 0.0 |
| betaine | | | | | | | | |
| Alkyl poly glycoside | 0.0 | 0.0 | 0.0 | 0.0 | 0.0 | 0.0 | 0.0 | 8.0 |
| C9-11 EO8 nonionic | 0.0 | 0.0 | 1.0 | 1.0 | 1.0 | 0.0 | 0.0 | 12.0 |
| Polypropylene glycol | 1.0 | 0.0 | 0.0 | 0.0 | 0.0 | 0.0 | 1.0 | 0.0 |
| 2000, (100%) | | | | | | | | |
| ethanol | 2.0 | 8.0 | 2.0 | 2.0 | 2.0 | 0.0 | 2.0 | 0.0 |
| Sodium cumene | 0.0 | 2.0 | 0.0 | 0.0 | 0.0 | 0.0 | 0.0 | 0.0 |
| sulfonate | | | | | | | | |
| Solvay PAP particle | 0.0 | 0.0 | 0.0 | 0.0 | 0.0 | 0.0 | 0.0 | 0.0 |
| Acticide M20 (MIT) | 0.008 | 0.008 | 0.008 | 0.008 | 0.008 | 0.008 | 0.008 | 0.008 |
| Phenoxyethanol | 0.2 | 0.2 | 0.2 | 0.2 | 0.2 | 0.2 | 0.2 | 0.2 |
| Perfume | 0.3 | 0.3 | 0.3 | 0.3 | 0.3 | 0.3 | 0.3 | 0.3 |
| TOTAL including | 100 | 100 | 100 | 100 | 100 | 100 | 100 | 100 |
| minors | | | | | | | | |
| Finished Product | Ex 17 | Ex 17 | Ex 18 | Ex18 | Ex19 | Ex 19 | Ex 20 | Ex 20 |
| Material Chemical Name | phase A | Phase B | phase A | Phase B | phase A | Phase B | phase A | Phase B |
| % of the Leg in Finish | 60 | 40 | 60 | 40 | 60 | 40 | 60 | 40 |
| Product | | | | | | | | |
| Cellulon PX | 0.1 | 0.1 | 0.1 | 0.1 | 0.1 | 0.1 | 0.1 | 0.1 |
| Microfibrous Cellulose | | | | | | | | |
| Pigmosol Blue 6900 | 0.0 | 0.0 | 0.0 | 0.0 | 0.0 | 0.0 | 0.0 | 0.0 |
| FD&C Yellow No. 5 | 20 ppm | 20 ppm | 20 ppm | 20 ppm | 20 ppm | 20 ppm | 20 ppm | 20 ppm |
| FD&C Blue No. 1 | 0.000 | 0.0 | 0.000 | 0.0 | 0.000 | 0.0 | 0.000 | 0.0 |
| Acusol OP 301 | 0.0 | 0.0 | 0.0 | 0.0 | 0.0 | 0.0 | 0.0 | 0.0 |
| ISP Captivate white bead | 0.0 | 1.0 | 0.0 | 1.0 | 0.0 | 1.0 | 0.0 | 1.0 |
| Expanded Aegean perlite | 0.0 | 0.0 | 0.0 | 0.0 | 0.0 | 0.0 | 0.0 | 0.0 |
| Timica extra large | 0.0 | 0.0 | 0.0 | 0.0 | 0.0 | 0.0 | 0.0 | 0.0 |
| sparkle 110s | | | | | | | | |
| Biron Silver CO | 0.2 | 0.0 | 0.2 | 0.0 | 0.2 | 0.0 | 0.2 | 0.0 |
| Iriodin 355 Glitter Gold - | 0.0 | 0.1 | 0.0 | 0.1 | 0.0 | 0.1 | 0.0 | 0.1 |
| Mica | | | | | | | | |
| NaOH (50%) | 0.3 | 0.3 | 0.3 | 0.3 | 0.3 | 0.3 | 0.3 | 0.3 |
| NaCl, (100%) | 1.0 | 1.0 | 1.0 | 1.0 | 1.0 | 1.0 | 1.0 | 1.0 |
| MgCl2 | 0.1 | 0.1 | 0.1 | 0.1 | 0.1 | 2.0 | 0.1 | 2.0 |
| Lial 123A sulfate | 5.0 | 0.0 | 5.0 | 0.0 | 6.0 | 0.0 | 6.0 | 0.0 |
| C12-C13 3 ethoxylated | 5.0 | 0.0 | 5.0 | 0.0 | 6.0 | 0.0 | 6.0 | 0.0 |
| sulfate | | | | | | | | |
| Shell A sulfate | 5.0 | 0.0 | 5.0 | 0.0 | 6.0 | 0.0 | 6.0 | 0.0 |
| C12-C14 Amine Oxide | 5.0 | 10.0 | 4.0 | 8.0 | 3.0 | 8.0 | 3.0 | 8.0 |
| Alkyl poly glycoside | 0.0 | 10.0 | 0.0 | 0.0 | 0.0 | 10.0 | 0.0 | 0.0 |
| C9-11 EO8 nonionic | 4.0 | 0.0 | 0.0 | 10.0 | 0.0 | 0.0 | 0.0 | 10.0 |
| Polypropylene glycol | 0.0 | 0.0 | 0.0 | 0.0 | 0.0 | 0.0 | 0.0 | 0.0 |
| 2000, (100%) | | | | | | | | |
| ethanol | 4.0 | 4.0 | 4.0 | 4.0 | 4.0 | 4.0 | 4.0 | 4.0 |
| GLDA | 0.6 | 0.6 | 0.6 | 0.6 | 0.6 | 0.6 | 0.6 | 0.6 |
| C10 to C14 cationic | 0.0 | 3.0 | 0.0 | 3.0 | 0.0 | 0.0 | 0.0 | 0.0 |
| dimethylethanol quat | | | | | | | | |
| Acticide M20 (MIT) | 0.008 | 0.008 | 0.008 | 0.008 | 0.008 | 0.008 | 0.008 | 0.008 |
| Phenoxyethanol | 0.2 | 0.2 | 0.2 | 0.2 | 0.2 | 0.2 | 0.2 | 0.2 |
| Perfume | 0.3 | 0.3 | 0.3 | 0.3 | 0.3 | 0.3 | 0.3 | 0.3 |
| TOTAL including | 100 | 100 | 100 | 100 | 100 | 100 | 100 | 100 |
| minors | | | | | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of cleaning dishware with a multiphase liquid detergent composition comprising the step of:
applying a composition onto a dishware, wherein said multiphase liquid detergent composition comprises:
(a) at least two visually distinct non-lamellar liquid phases having a high shear viscosity between about 100 cps and 15,000 cps at 20° C., a medium shear viscosity between about 5,000 cps and about 60,000 at 20° C., and a low shear viscosity between about 10,000 cps and 500,000 cps at 20° C.;
(b) an isotrophic surfactant present in one of said non-lamellar liquid phases; wherein said at least two visually distinct non-lamellar liquid phases have a yield stress value of between about 0.003 Pa and about 5.0 Pa.

2. The method of claim 1 wherein said at least two visually distinct phases have a high shear viscosity between about 2,500 cps and 5,000 cps at 20° C.

3. The method of claim 1 wherein said at least two visually distinct phase have a medium shear viscosity between about 20,000 cps and 40,000 cps at 20° C.

4. The method of claim 1 wherein said at least two visually distinct phase have a low shear viscosity between about 200,000 cps and 300,000 cps at 20° C.

5. The method of claim 1 wherein said composition further comprises a crystalline structurant present in one of said non-lamellar liquid phases.

6. The method of claim 1 wherein said composition further comprises about 0.001% to about 3%, by weight of said composition, of a crystalline structurant present in one of said non-lamellar liquid phases.

7. The method of claim 6 wherein said crystalline structurant is micro fibril cellulose.

8. The method of claim 7 wherein said crystalline structurant further comprises a charged hydrocolloid and a polymeric thickener.

9. The method of claim 5 wherein said crystalline structurant is an amido-gellant.

10. The method of claim 5 wherein said crystalline structurant is smectite clay.

11. The method of claim 5 wherein said crystalline structurant is a crystalline hydroxy-functional material selected from the group consisting of hydroxyl-containing fatty acids, fatty esters and hydrogenated castor oil derivatives.

12. The method of claim 1 wherein said surfactant is selected from the group consisting of: an anionic surfactant, cationic surfactant, nonionic surfactant, amphoteric surfactant, a zwitterionic surfactant, and mixtures thereof.

13. The method of claim 1 wherein said at least two visually distinct liquid phases comprise a benefit phase and a cleaning phase.

14. The method of claim 14 wherein said benefit phase comprises a benefit agent selected from the group consisting of: an enzyme, a skin rejuvenating active, a chelant, a cleaning particle, an exfoliating particle, an antibacterial agent, and mixtures thereof.

15. The method of claim 14 wherein said benefit phase comprises suspension particles.

16. The method of claim 15 wherein said suspended particles are selected from the group consisting of: deformable beads, encapsulates, microcapsules, polymeric particles, metal particles, pearlescent particles, pigments, minerals, plant materials, solid crystals, liquid crystals, gas bubbles, air bubbles, and mixtures thereof.

17. The method of claim 1 wherein said applying step comprises applying said composition in its neat form on to said dishware.

18. The method of claim 1 wherein said applying step comprises applying said composition in its diluted form on to said dishware.

19. The method of claim 1 further comprising the step of rinsing said dishware with water.

20. A method of cleaning dishware with a multiphase liquid detergent composition comprising the step of:
applying said composition on a dishware, wherein said multiphase liquid detergent composition comprises:
(a) at least two visually distinct non-lamellar liquid phases comprising a benefit phase and a cleaning phase and comprising a high shear viscosity between about 100 cps and 15,000 cps at 20° C., a medium shear viscosity between about 5,000 cps and about 60,000 at 20° C., and a low shear viscosity between about 200,000 cps and 300,000 cps at 20° C.;
(b) an isotrophic surfactant present in at least one of said visually distinct non-lamellar liquid phases;
(c) about 0.001% to about 3%, by weight of said composition, of a crystalline structurant present in at least one of said visually distinct non-lamellar liquid phases; and
rinsing said dishware.
